(19) United States
(12) Patent Application Publication
(10) Pub. No.: US 2007/0005520 A1
(43) Pub. Date: Jan. 4, 2007

(54) Systems and methods for visualizing arguments

(75) Inventors: Stephen G. Eick, Naperville, IL (US); Diane J. Cluxton, Naperville, IL (US); M. Andrew Eick, Farmington Hills, MI (US)

Correspondence Address: LATHROP & CLARK LLP, 740 REGENT STREET SUITE 400, P.O. BOX 1507, MADISON, WI, 537011507, US

(73) Assignee: SSS Research Inc.

(21) Appl. No.: 11/331,309

(22) Filed: Jan. 12, 2006

Related U.S. Application Data
(60) Provisional application No. 60/658,666, filed on Mar. 4, 2005.

(51) Int. Cl. G06F 15/18

(52) U.S. Cl. 706/12

(57) ABSTRACT

Hypotheses are questions of interest to an observer. Evidence are facts that establish or disprove hypotheses or sub-hypotheses. Inferences are logical links that connect facts to hypotheses as evidence. An argument is a set of facts linked by inferences to support or disprove a given hypothesis. Hypotheses, sub-hypothesis, facts, evidence, inference and arguments are visualized using a plurality of interrelated graphical user interfaces. A main visualization screen includes a fact visualization portion, a hypothesis visualization portion and an argument construction visualization portion. The evidence visualization portion comprises an evidence display portion, an evidence details portion and visualization selection widgets that allow different evidence visualization or marshaling techniques to be applied to visualize the facts. The argument construction visualization potion allows hypotheses, sub-hypotheses and conjectures to be associated into an argument, facts to be associated and inference links to be added to link the facts to various ones of the hypotheses.

This application claims priority to U.S. Provisional Patent application 60/658,666, filed Mar. 3, 2005, which is incorporated herein by reference in its entirety.

The subject matter of this application was made with U.S. Government support awarded by the following agencies, National Geospatial Intelligence Agency under contract number HM158204-C-0021. The United States has certain rights to this application.

### BACKGROUND OF THE INVENTION

1. Field of the Invention

This invention is directed to systems and methods for visualizing argument and its constituent elements and related data.

2. Related Art

An argument ties facts and evidence, which either support or refute a hypothesis, to that hypothesis in a logical sequence. In text books, arguments are often simple and easily followed. However, in the real world, arguments may be stunningly complex. Multiple hypotheses may be proposed to deal with the available facts. These hypotheses may be competing, contradictory or even mutually exclusive. The facts useable to support or refute these hypotheses are often contradictory, sometimes spoofed, and, all too frequently, missing. Reasons for linking specific facts to particular hypotheses as either supporting or refuting evidence can arbitrary, biased, and/or based on assumptions, which may themselves be less than fully appreciated. Creating robust, well-reasoned arguments that appropriately used the facts as evidence to support or refute the hypotheses in the presence of uncertain information is extremely difficult.

At its most basic level, an argument comprises hypotheses and zero, one or more sub-hypotheses, a plurality of facts, which become evidence when linked to hypotheses, sub-hypotheses or other facts, and inferences. These argument elements can be arranged in proof forms that capture the relationships among the evidence and the various hypotheses and sub-hypotheses. It is believed that conclusions derived from argument-based analyses of the available facts are more rigorous, robust and less sensitive to any biases of the person doing the analysis than results that are derived from more ad-hoc approaches.

Information visualization has long been recognized as a technique that allows deeper understanding of complex masses of information. It has been long recognized that information visualization can be used to understand structured arguments. Information visualization was first applied to structured arguments by Wigmore, who created techniques for visualizing evidence in legal proceedings. Wigmore, a famous evidence scholar, developed a graphical method for charting legal evidence that used an elaborate syntax and a set of symbols to represent statements, propositions, evidence, and inferential links.

Stephen Toulmin, in his book “The Uses of Argument” (Cambridge University Press, 1958) describes another method for visualizing an argument. However, both the Wigmore and Toulmin argument forms can become incredibly complex and unwieldy when having to deal with the mass of facts, evidence and available hypotheses that occur in real world situations. Thus, while Wigmore and Toulmin have pioneered the idea of using charts to visualize arguments, these techniques are typically impractical and are not widely used. There are many reasons why analysts have been reluctant to use Wigmore and Toulmin argument visualization. First, constructing Wigmorean or Toulminian evidence charts is exceedingly difficult and a significant chore, even when using conventional graph-drawing software packages. Second, as outlined above, the charts can be expansive and stunningly complex. One apocryphal story tells of a Wigmorean evidence chart that measured 37 feet in length.

Third, and most importantly, to construct Wigmorean or Toulminian evidence charts, the relationships between the evidence and the hypotheses must be known a priori. Thus, when using these techniques, the process of discovery is lost. That is, in most real-world situations, new facts are continually being found to fill in the holes in the current evidence, resulting in new insights being revealed, which in turn leads to recognizing that other evidence may be missing. Thus, Wigmorean or Toulminian evidence charts are typically applicable only after the evidence is understood.

### SUMMARY OF DISCLOSED EMBODIMENTS

Hypotheses are questions or conjectures of interest to an observer. Hypotheses may involve alternative possible explanations of facts, such as events or occurrences, possible answers, alternative estimates, or prediction of future events. Hypotheses may be contradictory or even mutually exclusive.

Hypotheses may also have substructure. That is, a high-level hypothesis may be partitionable into a set of sub-hypotheses that forms a hierarchical tree. The tree may in fact be several levels deep before the sub-hypothesis become questions that can be directly assessed and answered via available fact. A given cascading decomposition sequence of hypotheses and sub-hypotheses is not necessarily unique, and multiple sub-hypotheses may be simultaneously satisfied.

Facts become evidence when a fact becomes relevant to establishing or disproving a hypothesis or sub-hypothesis. Inferences are logical links that connect a fact to a hypothesis as evidence. Facts can also either support or refute an inference linking another fact to a hypothesis. Thus, facts can be linked by inferences to inferences as well as to hypotheses. Because the meaning or inference of a fact relative to a hypothesis can change as new facts are discovered and linked into the argument, analyzing a set of facts and organizing them into an argument that supports or disproves a given hypothesis is an interactive process. Thus, the static nature of the classical Wigmore and Toulmin approaches is ill-suited to situations, such as intelligence analysis, criminal investigations, and/or legal analysis of facts to determine potential causation and liability, because these techniques assume that the set of facts is complete and fixed and these techniques generate charts or visualizations that are not easily modifiable in view of new facts and/or new hypotheses or sub-hypotheses.

This invention provides systems and methods for visualizing hypotheses, facts and inferential networks linking the facts to the hypotheses.

This invention separately provides systems and methods for visualizing hypotheses, sub-hypotheses and conjectures.

This invention separately provides systems and methods for visualizing sets of facts and evidence.

This invention separately provides systems and methods for organizing interrelationships between facts within a set of facts.

This invention separately provides systems and methods for recording, organizing and or visualizing assumptions associated with hypotheses.

This invention separately provides systems and methods for assigning and visualizing values for evidentiary and inferential parameters.

This invention separately provides systems and methods for extracting information from documents into a collection of potentially relevant facts.

This invention separately provides systems and methods for visualizing an inference network of a hypothesis and facts relevant to that hypothesis.

This invention separately provides systems and methods for visualizing hypothesis and facts relevant to that hypothesis in a tabular form.

This invention separately provides systems and methods for visualizing facts in a timeline form.

This invention separately provides systems and methods for visualizing inter-relationships among facts, hypotheses, and conjectures.

This invention separately provides systems and methods for interactively creating, modifying, updating and altering Wigmorean and/or Toulminian argument forms.

This invention separately provides systems and methods for scoring a hypothesis and its sub-hypothesis based on the linked evidence using a Bayesian belief network.

In various exemplary embodiments of systems and methods according to this invention, an argument comprises hypotheses, sub-hypotheses and conjectures, facts, and inferences that link the facts as evidence to various ones of the hypotheses and sub-hypotheses. The hypotheses, sub-hypotheses, facts, evidence, inference and arguments are visualized using a plurality of interrelated graphical user interfaces or screens. In various exemplary embodiments, a main visualization screen includes a fact visualization portion, a hypothesis visualization portion and an argument construction visualization portion. In various exemplary embodiments, the hypothesis visualization portion includes a main hypothesis potion, a sub-hypothesis portion and a conjectures portion. In various exemplary embodiments, the evidence visualization portion comprises an evidence display portion, an evidence details portion and a variety of visualization selection widgets that allow different evidence visualization or marshaling techniques to be applied to visualize the facts. In various exemplary embodiments, the argument construction visualization potion allows hypotheses, sub-hypotheses and conjectures to be associated into an argument, various facts to be associated with the hypotheses and sub-hypotheses as evidence, and inference links to be added to link the facts to various ones of the hypotheses of the argument.

In various exemplary embodiments, a hypothesis properties graphical user interface or screen allows various properties about a particular hypothesis to be viewed and made explicit. In various exemplary embodiments, the hypothesis properties screen allows the hypothesis to be named, to be given a description, and various assumptions to be made explicit or associated with the hypothesis. In various exemplary embodiments, the hypothesis properties screen includes a portion that allows various facts that have been associated with the particular hypothesis to be viewed.

In various exemplary embodiments, an evidence properties graphical user interface or a screen allows a particular fact to be named and described and values for various parameters to be associated with each different fact. In various exemplary embodiments, the parameters include source parameters and applicability parameters. In various exemplary embodiments, an evidence graphical user interface or screen allows for evidence facts to rearranged, sorted, filtered, and marshaled according to the evidence parameters including the source and applicability parameters. In various exemplary embodiments, the evidence facts can be organized into an evidence grid or the like.

In various exemplary embodiments of systems and methods according to this invention, a tool bar or timeline can be incorporated into a word processing program or the like to allow a portion of a document being viewed with that word processing program to be copied and incorporated into an argument as a new fact.

In various exemplary embodiments, an argument visualization graphical user interface or screen allows the inferences of an argument to be viewed and the visualization parameters modified.

In various exemplary embodiments, a fact or evidence marshalling screen or set of screens allows a set of facts, some, none or all of which may have been associated with one or a variety of hypotheses as evidence, to be visualized relative to each other and/or to those one or more hypothesis in one or more of a tabular form, a timeline form, a link form or the like. In various exemplary embodiments of systems and methods according to this invention, the facts, evidence, inferential links and hypothesis of an argument can be visualized using either Wigmorean forms or Toulminian forms. In various exemplary embodiments, the visualization can be toggled between the Wigmorean form and the Toulminian form.

In various exemplary embodiments, one or more hypotheses of an argument can be scored by creating a Bayesian belief network out of each hypotheses and the various facts that are linked to each hypothesis as evidence using the inferential links. In various exemplary embodiments, each hypothesis can be analyzed independently, with each hypothesis being scored independently of the other hypotheses. In various other exemplary embodiments, the hypotheses can be scored together, where the sum of these scores for the hypotheses must total one. In various exemplary embodiments, the scoring can be toggled between these two scoring functions.

These and other features and advantages of various exemplary embodiments of systems and methods according to this invention are described, or are apparent from, the following detailed description of various exemplary embodiments of the systems and methods of according to this invention.

### BRIEF DESCRIPTION OF DRAWINGS

Various exemplary embodiments of the systems and methods of this invention will be described in detail, with reference to the following figures, wherein:

FIG. 1 shows a first exemplary embodiment of a hypothesis visualization graphically user interface or screen according to this invention;

FIG. 2 shows a second exemplary embodiment of a hypothesis visualization graphically user interface or screen according to this invention;

FIG. 3 shows in greater detail one exemplary embodiment of a hypothesis overview portion of a hypothesis visualization screen according to this invention;

FIG. 4 illustrates one exemplary embodiment of a hypothesis properties graphical user interface or screen according to this invention;

FIG. 5 illustrates one exemplary embodiment of an evidence properties graphical user interface or screen according to this invention;

FIG. 6 illustrates one exemplary embodiment of a graphical user interface widget usable with a word processing program or other data manipulation application that allows documentary or visual evidence to be viewed and/or manipulated;

FIG. 7 illustrates a first exemplary embodiment of an argument visualization graphical user interface or screen according to this invention;

FIG. 8 illustrates a second exemplary embodiment of the argument visualization graphical user interface or screen according to this invention;

FIG. 9 illustrates one exemplary embodiment of a hypothesis assumption recording graphical user interface according to this invention;

FIG. 10 illustrates one exemplary embodiment of a hypothesis analyzer graphical user interface or screen according to this invention;

FIG. 11 illustrates one exemplary embodiment of a time analysis graphical user interface according to this invention;

FIG. 12 illustrates one exemplary embodiment of a fact link analysis graphical user interface according to this invention;

FIG. 13 illustrates one exemplary embodiment of graphical user interface icons usable in the hypothesis visualization portion of a hypothesis visualization graphical user interface or screen according to this invention;

FIG. 14 illustrates one exemplary embodiment of a visualization of a Wigmorean argument form according to this invention;

FIG. 15 illustrates one exemplary embodiment of a Toulminian argument according to this invention;

FIG. 16 illustrates one exemplary embodiment of a Bayesian belief network usable to score an argument according to this invention; and

FIG. 17 is a flowchart outlining one exemplary embodiment of a method for visualizing and analyzing an argument created using the visualization techniques according to this invention.

### DETAILED DESCRIPTION OF DISCLOSED EMODIMENTS

The essential aspects of an argument include at least three components, namely, evidence, hypothesis and inferences. Each of these components is philosophically deep and related to the fundamental aspects of science and logic. In fact, at a basic level, evidence has been described as being unable to be defined in such a way that its definition is not circular.

Evidence involves a fact and a hypothesis that is of interest to an observer. Facts come in an essentially unlimited variety and form. Facts depend upon the observers supplying the facts. Accordingly, facts often change through time. In general, the intelligence community, the scientific community and other groups who deal with facts on a daily basis have identified four fundamental aspects of facts. First, it is impossible to know all of the facts regarding a particular situation. Second, there is frequent disagreement about what the facts are regarding some situations of concern. Persons having different points of a view or approaching the problem from different avenues may see “the facts” quite differently. Third, facts are frequently not stationary. A source that was believable or credible in the past may now appear to be untruthful. Accordingly, the facts supplied by that source may have to be reevaluated as the credibility or other properties of that source change over time. Finally, what are defined as “facts” depends upon the extent to which those facts have corroborating evidence from other, preferably independent, sources.

A fact becomes evidence when that fact tends to make a hypothesis either more likely or less likely to be correct. That is, a fact becomes evidence when it is relevant, rather than irrelevant, to a particular hypothesis.

Although there are many species of evidence, for inferential purposes, there appear to be a relatively small number of distinct types. These types include tangible evidence, i.e., physical items that can be examined such as, for example, objects, documents, images, charts, measurements, direct recordings and the like. Evidence can also be testimonial, i.e., statements made by a person relating their direct perceptions, such as things heard, seen, felt, smelled or tasted. Testimonial evidence can also include opinion statements made by experts or laymen based on their interpretation of directly-experienced facts, such as those indicated above. Testimonial evidence can also encompass second-hand statements, such as gossip, hearsay and the like. Evidence can also be authoritative, i.e., generally accepted as true without requiring any evidence that the authoritative evidence is in fact true.

Evidence can also be weighted for its usefulness in proving or disproving a hypothesis. Various parameters for evidence include relevance, credibility and admissibility. Relevance describes how directly the fact influences or tends to prove or disprove the hypothesis. For example, evidence can be directly relevant, circumstantially relevant, or even of ancillary relevance. Credibility describes the weight or certainty the analyst has that the underlying fact is in fact true. Finally, admissibility goes to whether the evidence is even allowed to be used. For example, in the U.S. legal system, there are strict rules that determine whether evidence can be admitted. For example, in criminal proceedings, evidence obtained by illegal searches is inadmissible. In the U.S. legal system, judges determine the relevance and admissibility of facts into evidence, while juries are responsible for assessing the credibility of facts that have been entered into evidence. In scientific communities, evidence is only admissible to prove or disprove a hypothesis if it can be repeated independently by other researchers. Intelligence communities are also limited to evidence admissibility rules. For example, there are strict laws that prohibit U.S. intelligence agencies from gathering evidence on U.S. citizens; that is, such evidence is inadmissible.

Once a fact is determined to be relevant to a hypothesis, credible, in that that fact is at least likely to be accurate and true, and admissible, the effect that evidence can have on a hypothesis can be positive or supportive of a hypothesis, negative, i.e., contradicting or tending to disprove a hypothesis, or missing. For example, the fact that an expected event occurred is positive evidence, as is the fact that an unexpected event did not occur. In contrast, the fact that an expected event did not occur, or that an unexpected event did occur, is negative evidence. Missing evidence is evidence that is expected but for some other reason, other than the hypothesis being wrong, was not produced or even discoverable. In the U.S. legal system, when evidence is missing, it is presumed to be against the interest of the party who is most interested in relying on that evidence; otherwise, the missing evidence would have been produced. In contrast, in intelligence analysis, missing and negative evidence may be just as powerful in establishing inferences as positive or negative evidence. In any case, missing evidence should not be overlooked.

There may be recurrent combinations of evidence. This occurs when multiple individual facts in evidence are related to the same hypothesis. There are two possible types of relationships, dissonant and harmonious. Two pieces of harmonious evidence tend to both support or both disprove a particular hypothesis. In contrast, two pieces of dissonant evidence contain internal conflicts such as when each piece of evidence implies that the other is true, but each piece of evidence leads to different conclusions about the ultimate hypothesis. Dissonant combinations of evidence may be contradictory or conflicting. Contradictory evidence involves events that are mutual exclusive. Contradictions are usually settled on the basis of evidence credibility. Conflicting evidence involves two events that can both occur jointly but seem to favor different hypothesis. Similarly, harmonious evidence can be either corroborative or convergent. Corroborative evidence involves concurrent evidence about the same event, or ancillary evidence that supports the credibility of sources of other evidence. Convergent evidence occurs when two or more items of evidence about a different event all seem to favor the same hypothesis.

Thus, at a superficial level, evidence seems uncomplicated. However, lurking just below this superficial level is an ocean of subtlety. Systems and methods for visualizing arguments according to this invention help evidence analysts, such as intelligence analysts, lawyers, judges, juries, scientists and other actors who need to draw conclusions from masses of evidentiary facts, to navigate through these subtleties by capturing key characteristics of facts and evidence with data structures. In various exemplary embodiments, systems or methods for visualizing arguments according to this invention, allow these evidentiary facts to be presented to a user in a dialog and allow the user to organize such evidentiary facts around arguments and hypothesis.

As discussed above, hypotheses are questions or conjectures of interest to an observer. Hypotheses may involve alternative explanations, possible answers, or alternative estimates. One exemplary embodiment of a hypothesis H is “Iraq had weapons of mass destruction (WMD)”. The complimentary hypothesis H^{C} is “Iraq did not have WMD”. Hypotheses such as the ones discussed above seek to provide estimative intelligence regarding political, military, economic and social factors that influence policy makers.

Hypotheses may have substructures. That is, it is sometimes possible to divide, decompose or partition a high-level hypothesis into a set of sub-hypotheses. In various exemplary embodiments, a particular hypothesis can be composed into a hierarchal tree of sub-hypotheses, sub sub-hypotheses, sub-sub-sub-hypotheses and the like. Thus, the hierarchal tree may be several levels deep. Each level can be directly assessed and answered by evidentiary facts regardless of how far down the tree a sub-hypothesis occurs. For example, the hypothesis H outlined above may be decomposed into: H “Iraq had nuclear WMD”, Sub-H: H₁ “Iraq had biological WMD”, Sub-H: H₂ “Iraq had chemical WMD”, Sub-H: H₃ “Iraq had other WMD” and the like. Furthermore, the first sub-hypothesis H₁ can be further decomposed into two or more sub-hypothesis, such as Sub-Sub-H: H₁₁ “Iraq had nuclear WMDs in Baghdad” and Sub-Sub-H: H₁₂ “Iraq had nuclear WMDs in Mosul.”

It should be appreciated that the cascading decomposition sequence outlined above is not necessarily unique. Thus, multiple sub-hypothesis may be simultaneously satisfied.

The proof state, or likelihood, of any hypothesis or sub-hypothesis may be captured by the certainty or uncertainty of the evidence credibility and the weight of support the evidence provides to the hypothesis. In various exemplary embodiments of systems and methods for visualizing arguments according to this invention, certainty is represented by a number between 0 and 1 that represents the probability or likelihood that a particular hypothesis or sub-hypothesis is true. In various exemplary embodiments accordingly to this invention, the certainty value of a hypothesis is determined based upon the evidentiary facts associated with a hypothesis, the relevance and credibility of those evidentiary facts and the inferential strength of those evidentiary facts.

An inference is a conclusion that connects evidentiary facts to a hypothesis. Inferences are logical arguments, sometimes referred to as generalizations, which support the conclusion called for in a hypothesis. Inferences may also connect one sub-hypothesis with another sub-hypothesis higher up in the hierarchal tree or with the ultimate hypothesis that lies at the root of the hierarchal tree. A reasoning chain is a sequence of inferences that start with an evidentiary fact and lead to one or more hypothesis. In particular, it should be appreciated that there may be several sub hypotheses within a particular inference chain.

In various exemplary embodiments according to this invention, a particular inference is parameterized by its strengths and its direction. In particular, its strength or inferential force defines how strongly the evidence supports, or disproves or contradicts, a particular hypothesis. The direction defines whether the evidentiary facts support, or disprove or contradict the hypothesis. The inferential force, i.e., the strength or weight, of an inference is related to the credibility and relevance of each of the evidentiary facts that that inference connects to the given hypothesis. For example, evidence with weak credibility and with weak relevance will generally not have strong inferential weight, thereby providing a low level of certainty in the hypothesis.

An argument or inference network is a directed acyclic graph (DAG) that has a plurality of nodes connected by a plurality of edges. The nodes generally represent possible sources of uncertainty, such as, for example, evidentiary facts, sub-hypothesis, the ultimate hypothesis and the like. In contrast, the edges represent the various inferences and/or inference chains.

However, there appears to be no simple way to determine the inferential strength of evidence and inferences in arguments. In fact, determining the inferential strength of arguments has been a goal of legal scholars, scientists, mathematicians and statisticians since at least the 1600's. Unfortunately, there is no commonly agreed-upon technique to determine the inferential strength of evidence and inferences in arguments. In various exemplary embodiments of systems and methods for visualizing arguments according to this invention, Bayesian probabilistic methods are used, where the evidence credibility and hypothesis uncertainty are modeled using a zero-one scale that roughly corresponds to a probability. The relevance of a given inference to a particular hypothesis is then the conditional probability of the hypothesis given the evidentiary facts.

In particular, the likelihood scores for a particular hypothesis are normalized to probabilities. In various exemplary embodiments of systems and methods for visualizing arguments according to this invention, at least two scoring functions or schemes can be used. In a first scoring function, the hypotheses are scored as competing, where only one hypothesis can be true. In this case, the probabilities associated with the hypotheses must sum to one. In a second scoring function, each of a plurality of hypotheses is evaluated independently. Thus, each hypothesis is given a score between zero and one, independently of the probability scores of the other hypothesis.

Constructing an argument is a creative task that involves looking at facts, formulating conjectures, creating hypothesis, associating facts with hypothesis as evidence, creating sub-hypothesis, and iterating these steps. Various exemplary embodiments of systems and methods for visualizing arguments according to this invention allow analysts to perform these steps in an interactive, structured environment that allows each of these actions to be performed independently of the others and that allows the user to repeatedly switch between these actions. In various exemplary embodiments, systems and methods for visualizing arguments according to this invention encourage analysts to explore new hypotheses and alternative explanations for the facts. Various exemplary embodiments of systems and methods for visualizing arguments according to this invention allow facts to be marshaled and organized as evidence around various hypotheses.

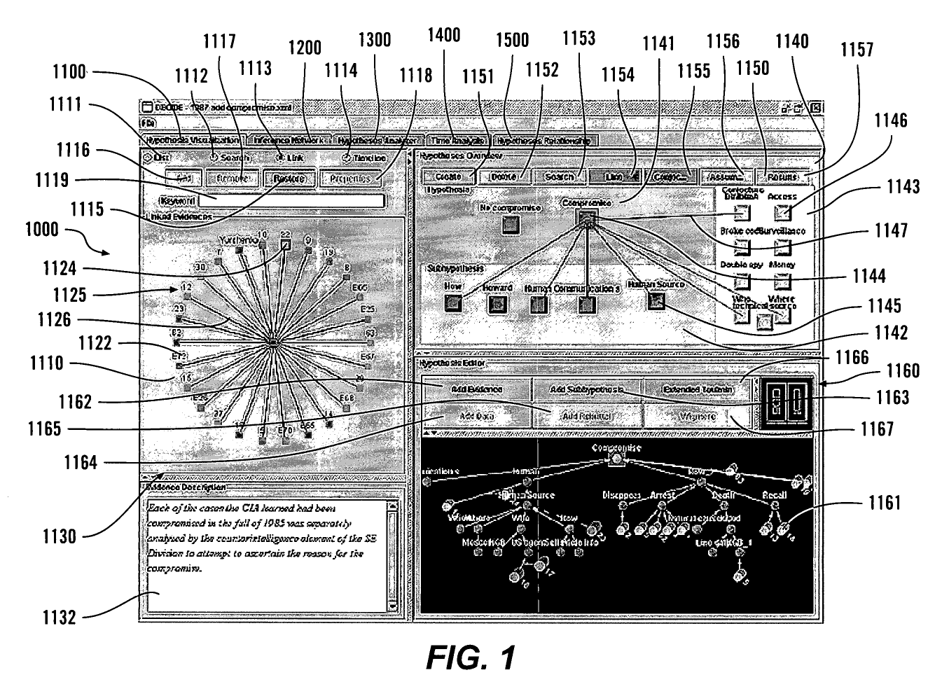

In particular, in various exemplary embodiments, systems and methods for visualizing arguments according to this invention allows an analyst to add facts, browse facts and evidence, create hypotheses, associate facts with hypothesis as evidence, set the relevance and credibility of facts and evidence, combine hypotheses, restructure hypotheses, edit previously created arguments, and use traditional proof constructs to capture the inferential structure of the relationships between the evidentiary facts and a given hypothesis. These features, which can be provided in various exemplary embodiments of the systems and methods for visualizing arguments according to this invention, will be described in greater detail with respect to FIGS. 1-16.

FIG. 1 shows one exemplary embodiment of an argument visualization graphical user interface 1000 according to this invention. As shown in FIG. 1, the argument visualization graphical user interface 1000 includes a hypothesis visualization tab 1100, an argument visualization tab 1200, a hypotheses analyzer tab 1300, a time analysis tab 1400, and a hypotheses relationship tab 1500. It should be appreciated that the argument visualization graphical user interface 1000 can include any one or more of these tabs 1100-1500, as well as any desired additional tabs.

As shown in FIG. 1, the hypothesis visualization tab 1100 includes an evidence marshaling portion 1110, a hypothesis overview portion 1140, and an argument construction portion 1160. The evidence marshaling portion 1110 allows facts and evidence to be viewed in a variety of different ways and facts, whether in evidence or not, to be related to each other. The hypothesis overview portion 1140 allows various hypotheses, sub-hypotheses and conjectures to be identified, various sub-hypothesis to be associated with one or more of the hypotheses or conjectures and various conjectures to be maintained. The argument construction portion 1160 allows evidence and inferential links to be associated with various hypotheses and sub-hypotheses, and the creation of multiple sub-hypotheses within a particular hypothesis.

As shown in FIG. 1, the evidence marshaling portion 1110 includes a plurality of selection widgets 1111-1114 that allow different visualization techniques to be applied to a set of facts and/or evidence. The evidence marshalling portion 1110 allows the user to find relationships between the facts and/or the evidence, so that facts can be added as evidence, as desired by the user, to an argument being constructed or edited using the argument construction portion 1160. In the exemplary embodiment shown in FIG. 1, the selection widgets 1111-1114 are implemented as radio buttons. In the exemplary embodiment shown in FIG. 1, the different visualization techniques implemented in this exemplary embodiment include a list visualization, a search visualization, a link analysis visualization and a timeline visualization. In particular, the radio buttons 1111-1114 allow the list visualization, the search visualization, the link analysis visualization and the timeline visualization, respectively, to be selected. In FIG. 1, the link analysis visualization radio button 1113 has been selected. In response, a link analysis visualization 1120 is displayed in a visualization area 1130 of the evidence marshaling portion 1110.

As shown in FIG. 1, the evidence marshaling portion 1110 also includes a number of action widgets 1115-1119 that allow various actions to be performed on the particular fact visualization shown in the visualization area 1130. It should be appreciated that, depending on the visualization, various ones of the action widgets 1115-1119 may be activated and/or displayed. In the exemplary embodiment shown in FIG. 1, because the link analysis visualization 1120 is displayed in the visualization portion 1130, the restore action 1115 and the key word search action 1119 are activated, while the add action 1116, the remove action 1117 and the properties 1118 are deactivated. In the exemplary embodiment shown in FIG. 1, when the restore widget 1115 is selected, the list analysis visualization 1120 is again activated. In contrast, when a search term is placed in the keyword widget 1119 and the keyword search widget 1119 activated, the various fact items shown in the fact visualization area 1130 will be searched to identify facts items having that keyword phrase on their description.

In the exemplary embodiment shown in FIG. 1, the link analysis visualization 1120 includes a number of satellite facts 1121 that are linked by inferential links 1122 to a central fact 1123. The link analysis visualization 1120 allows the user to find relationships between the facts, so that facts can be added as evidence, as desired by the user, to an argument being constructed or edited using the argument construction portion 1160. It should be appreciated that, in the linked evidence visualization 1120, the user will typically select a central fact 1123. The other facts or evidence are then inferentially linked to that selected central fact 1123 when displayed. As shown in FIG. 1, in various exemplary embodiments, each of the satellite facts 1121 and the central fact 1123 has a fact name or label associated with it and has a color associated with it. It should be appreciated that, in various exemplary embodiments, the color of the fact can be used to convey information, such as the key evidence, the credibility or the value of any other parameter associated with the facts or the like.

As shown in FIG. 1, any one of the satellite facts 1121 or the main central fact 1123 can be selected. In FIG. 1, a particular satellite fact 1124 has been selected. In response, an evidence description display area 1132 of the visualization portion 1130 is displayed. The evidence description display area displays the text of the evidence or any other appropriate evidence description that is appropriate. In various exemplary embodiments, facts are added as evidence to an argument by selecting a fact displayed in the link analysis visualization 1120 and dragging and dropping the selected fact from the link analysis visualization 1120 to the desired location in the argument being constructed or edited using the argument construction portion 1160.

As shown in FIG. 1, in various exemplary embodiments, the hypothesis overview portion 1140 includes an active hypothesis portion 1141, an active sub-hypothesis portion 1142 and conjecture portion 1143. As shown in FIG. 1, in various exemplary embodiments, the active hypotheses 1144 located in the active hypothesis portion 1141 are shown using one color, while the active sub-hypotheses 1145 located in the active sub-hypothesis portion 1142 are shown using a second color. Similarly, the conjectures 1146 located in the conjecture portion 1143 are shown using a third color. Thus, it is easy for the analyst to readily distinguish between the root active hypotheses 1144, the sub-hypotheses 1145 and the conjectures 1146. It should be appreciated that all of the hypotheses 1144, the sub-hypotheses 1145 and the conjectures 1146 are fundamentally identical. The sub-hypotheses 1145 tend to be the main lines of thought depending from a given hypothesis.

The main difference between the hypotheses 1144, the sub-hypotheses 1145 and the conjectures 1146 is their support level. That is, a sub-hypothesis 1145 has evidence that supports a hypothesis 1144, and can be linked to any other hypothesis, i.e., either to a main hypothesis 1144 or to some other sub-hypothesis 1145. Likewise, conjectures 1146 are hypotheses that have not yet been made active hypotheses 1144 by placing them in the active hypothesis portion 1141 or made active sub-hypotheses 1145 by placing them in the active sub-hypothesis potion 1142. The conjecture portion 1143 is used to store-house the analysts' thoughts about possible hypotheses before those possible hypotheses become developed enough to warrant being placed into either the active hypothesis portion 1141 as an active hypothesis 1144 or the active sub-hypothesis portion 1142 as an active sub-hypothesis 1148. A conjecture 1146 may not warrant being placed in to either the active hypothesis portion 1141 or the active sub-hypothesis portion 1142 because insufficient facts can be linked evidentially to that conjecture 1146 or for any other reason where the analyst is not yet ready to treat that conjecture 1146 as a full hypothesis 1144 or sub-hypothesis 1145.

As shown in FIG. 1, in various exemplary embodiments, any number of links 1147 are provided between a primary hypothesis 1144 and the various sub-hypotheses 1145 located in the active sub-hypothesis portion 1142 and/or various ones of the conjectures 1146 located in the conjecture portion 1143. Thus, it should be appreciated that, while a conjecture 1146 may not yet rise to the level of a full sub-hypothesis 1145, it can still be linked using the links 1147 to a main hypothesis 1144 or even to a sub-hypothesis 1145 that is located in the active hypothesis or sub-hypothesis portions 1141 and/or 1142, respectively. Furthermore, the links 1147 can also be used to link two conjectures 1146 together.

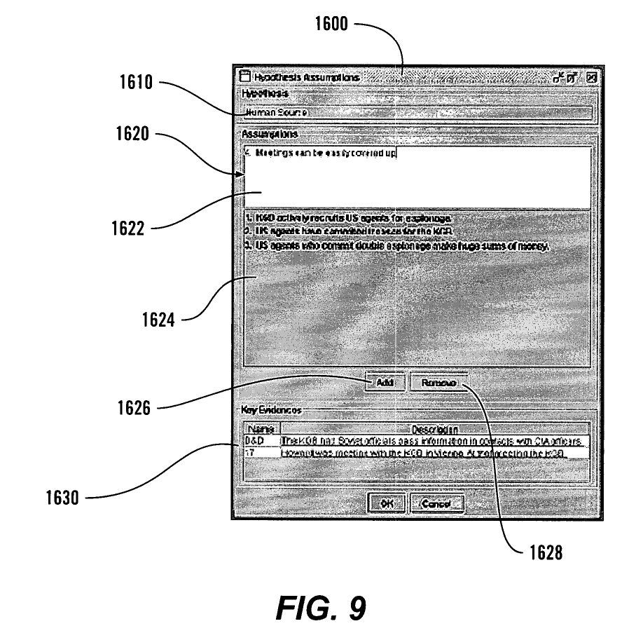

As shown in FIG. 1, the hypothesis overview portion 1140 also includes a number of action widgets 1150 that are used to access an action or function that has been implemented in the argument visualization systems and methods according to this invention, i.e., that allow certain actions to be taken with respect to the hypotheses 1144, sub-hypotheses 1145 and/or conjectures 1146. In various exemplary embodiments, the action widgets included in the set of action widgets 1150 include a create widget 1151, a delete widget 1152, a search widget 1153, a line widget 1154, a conjecture widget 1155, an assumption widget 1156, and a results widget 1157. The create widget 1151 is used to create a new hypothesis, sub-hypothesis or conjecture. The delete widget 1152 is used to delete a previously created hypothesis, sub-hypothesis or conjecture. The search widget 1153 is used to search within the hypotheses, sub-hypotheses and conjectures or within the description portion of a fact based on a keyword selection criterion. The user can search within the hypotheses for evidence, main lines of reasoning, etc. The line widget 1154 is used to create a link line 1147 between a particular hypothesis and sub-hypothesis or conjecture, between a sub-hypothesis and another sub-hypothesis or a conjecture, or between two conjectures. The conjecture widget 1155 is a toggle button that allows the user to “hide” or reveal the conjecture portions 1143. It is a user preference widget. The assumption widget 1156 is used to access the hypothesis assumption graphical user interface 1600, which is shown in FIG. 9 and discussed to greater detail below. The results widget is used to directly link the user to a blank Microsoft Word document. This field is created so the analyst can record analytic results in the Microsoft environment in a textual format for superiors, policy makers, etc.

As shown in FIG. 1, the argument construction portion 1160 includes an argument editing portion 1161 and a plurality of action widgets 1162-1167. As shown in FIG. 1, in various exemplary embodiments, the argument editing portion 1161 shows an argument, which includes a given hypothesis 1144, the inferential links 1147 between that given hypothesis 1144 and any sub-hypotheses 1145 and evidentiary facts 1121 that directly support or refute that hypothesis 1144. The argument editing portion 1161 also shows any sub-sub-hypotheses 1145 that are inferentially linked to another sub-hypothesis 1145 and any evidentiary facts 1121 that inferentially linked to those sub-hypotheses 1145, sub-sub-hypotheses 1145 and the like. The argument editing portion 1161 also shows evidentiary facts 1121 that are inferentially linked to an inferential link 1147 between some other evidentiary fact and some hypothesis 1144, sub-hypothesis 1145, sub-sub-hypothesis 1145 and the like, as supporting or corroborating, or as conflicting or refuting, evidence.

As shown in FIG. 1, the evidence can be either supporting or conflicting, depending on the type of inferential link between that evidentiary fact and the hypothesis 1144, the sub-hypothesis 1145, the sub-sub-hypothesis 1145 or other evidentiary fact 1121 shown in argument visualization portion 1161. The appearance of the inferential links 1147 between an evidentiary fact and the element to which that fact is linked indicates whether that evidentiary fact supports or refutes the main hypothesis 1144 of the argument. The appearance can also indicate that the evidentiary fact supports or refutes a sub-hypothesis 1145, an inferential link 1147 between to other elements of the argument or the like.

As shown in FIG. 1, in the argument editing portion 1161, the primary or main hypothesis 1144, the sub-hypotheses 1145 and the standards evidentiary facts 1121 are shown using the same colors as used in the evidence marshalling portion 1110 and the hypothesis overview portion 1140. In this exemplary embodiment, supporting inferences between evidentiary facts and the sub-hypotheses 1145 or hypothesis 1144 or between the sub-hypotheses 1145 and other sub-hypotheses 1145 or the main hypothesis 1144 are shown as solid lines, while contradicting inferences are shown as broken lines. Finally, evidentiary facts 1121 that are merely supportive or corroborative are shown in a different color, such as, for example, yellow. The reddish orange color shown in FIG. 1 shows user defined key evidence, i.e., evidence that the user has distinguished as highly supportive or contradictory to the hypothesis and crucial to the argument structure.

In various exemplary embodiments, the action widgets 1162-1167 of the argument construction portion 1160 include an add evidence widget 1162, an add sub-hypothesis widget 1163, an add data widget 1164, an add rebuttal widget 1165, an extended Toulmin widget 1166 and a Wigmore widget 1167. The add evidence widget 1162 allows the user to add evidentiary facts and create inferential links from those evidentiary facts to the main hypothesis 1144, a desired sub-hypothesis 1145 or other evidence. In various exemplary embodiments, the evidence is added by selecting a fact displayed in the evidence marshalling portion 1110 and dragging and dropping the selected fact from the evidence marshalling portion 1110 to the desired location in the argument being constructed or edited using the argument construction portion 1160.

The add sub-hypothesis widget 1163 allows the user to select a hypothesis 1144, a sub-hypothesis 1145 or a conjecture 1146 from the hypothesis overview portion 1140 and drag and drop it into a Wigmorean data form shown in the argument visualization portion 1160. The add sub-hypothesis widget 1163 also allows the user to create an inferential link 1147 between that hypothesis 1144, sub-hypothesis 1145 or conjecture 1146 and some previously placed the main hypothesis 1144, some other hypothesis 1144 added as a sub-hypothesis, a sub-hypothesis 1145 or conjecture 1146 added as a main hypothesis or a sub-hypothesis. The add data widget allows the user to add a data element to a Toulminian data form shown in the argument visualization portion 1160. The add rebuttal widget 1165 allows the user to add a rebuttal element to a Toulminian data form shown in the argument visualization portion 1160. The extended Toulmin widget 1166 converts an argument being visualized in the argument visualization portion 1161 from the Wigmorean form to the Toulminian form enables the widgets 1164 and 1165, and disables the widgets 1162 and 1163.

In contrast, the Wigmore widget 1167 converts and displays an argument being visualized in the visualization portion 1161 using the Toulminian form into an argument visualized using the Wigmorean form, enables the widgets 1162 and 1163 and disables the widgets 1164 and 1165. Accordingly, when the Wigmorean form is being displayed, as shown in FIG. 1, the Wigmore widget 1167 is deactivated, as are the add data and add rebuttal widgets 1164 and 1165 that refer to data structures used in the extended Toulmin form. Similarly, when the extended Toulmin form is used to visualize the argument in the argument visualization portion 1161, the extended Toulmin widget 1166 is deactivated, while the Wigmore widget 1167 is activated. It should be appreciated that, in this case, the add data and add rebuttal widgets 1164 and 1165 are activated, while the add evidence and add sub-hypothesis widgets 1162 and 1163, which refer to Wigmorean data structures, are deactivated.

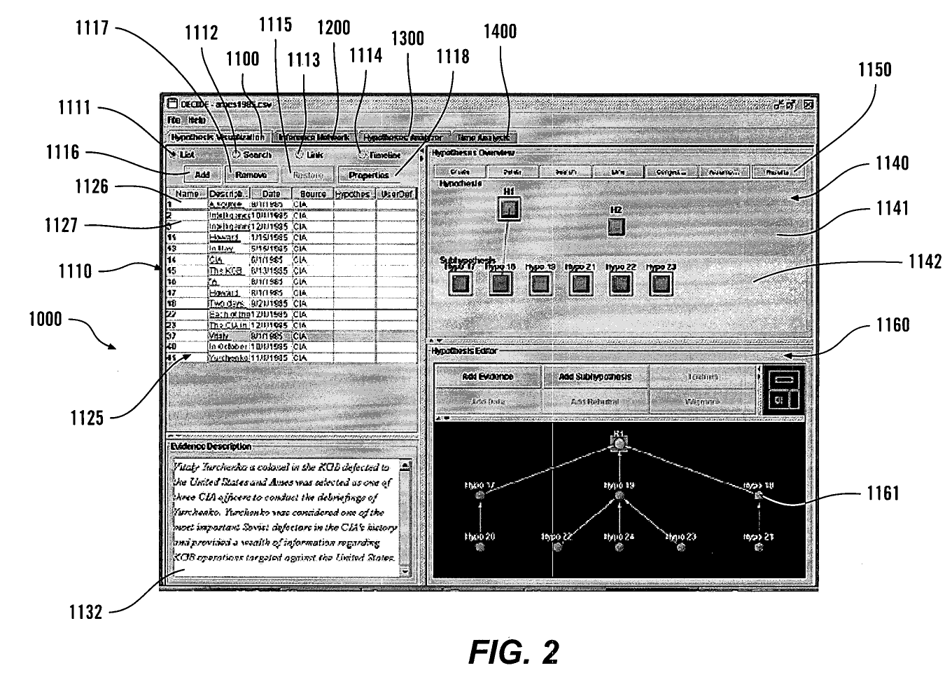

FIG. 2 shows a second exemplary embodiment of the hypothesis visualization tab 1100. In this second exemplary embodiment, the list selection widget 1111 of the evidence marshalling portion 1110, rather than the link selection widget 1113, has been selected. According, rather than displaying the link analysis visualization 1120 in the evidence visualization portion 1130, a tabular list 1125 of the active fact elements is displayed. At the same time, the various action widgets 1116-1119 are modified appropriately. In this case, the add widget 1116, the remove widget 1117 and the properties widget 1118 are activated, while the restore widget 1115 is deactivated and the keyword search widget 1119 is not displayed.

As shown in FIG. 2, the tabular list 1125 includes a column title bar 1126 and a plurality of rows 1127, where each row 1127 is associated with one fact element. As shown in FIG. 2, in various exemplary embodiments, the tabular list or form 1125 includes various columns. The column title bar 1126 includes a name and an active widget for each column. Clicking on one of these active widget causes the evidence to be sorted in an ascending or descending list based on the data in that column. Clicking that active widget for that column again switches between the ascending or descending sort and the opposite descending or ascending sort. It should be appreciated that, in various other exemplary embodiments, the columns in the evidence grid may act as filters, as pivots or the like, and may include other evidence properties, such as, for example, evidence credibility parameters.

As shown in FIG. 2, as shown in various exemplary embodiments, the columns of the tabular form 1125 include a name column, a description column, a date column, a source column, a hypothesis column, and a user defined column. In the name column, the name of the particular evidentiary fact is set forth. In the description column, the description that is shown in full in the evidence description portion 1132 is displayed, at least in part. The description column also provides a hyperlink to the source document. By clicking on the description column, the user can access the source document. The date column stores the date that the evidence was entered into intelligence. The date of the event can be shown in a timeline visualization contained in the time analysis tab 1400. The source column indicates the source for the evidentiary fact, while the hypothesis indicates which hypothesis or sub-hypothesis a particular evidentiary fact is linked to. Finally, the user define column allows any bit of information based on the users desired information structure, to be added to and/or displayed for each evidentiary fact. In FIG. 2, in the argument visualization portion 1161, no evidentiary facts have yet been associated with the argument being visualized. Accordingly, there is no data in the hypothesis column of the tabular form 1125.

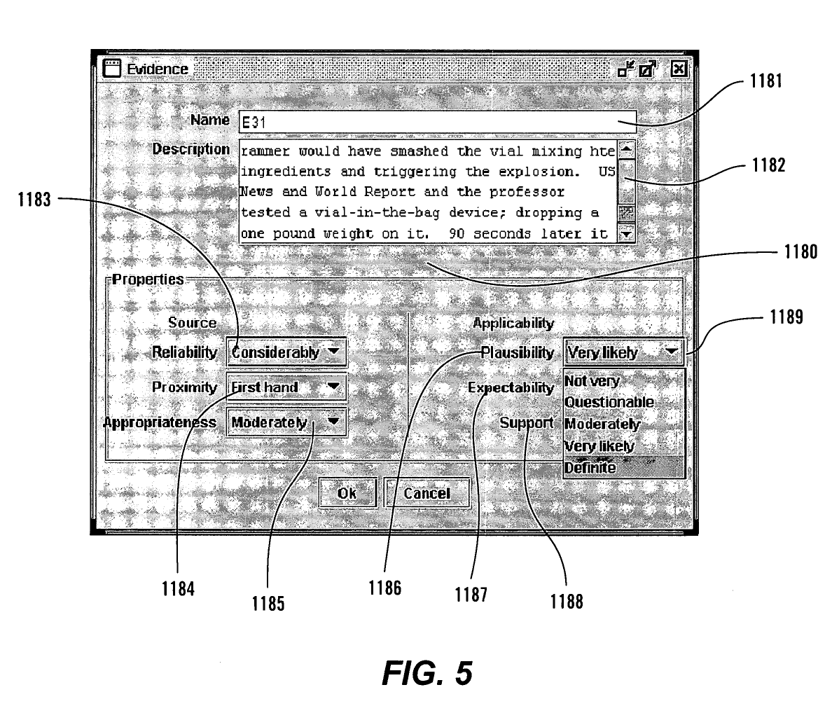

In the evidence marshalling portion 1110 shown in FIGS. 1 and 2, double clicking on a fact that is currently displayed in the evidence marshalling portion 1110 causes a browser window to open that displays the source document or other source material that the fact was obtained from. Right clicking on that fact causes the evidence graphical user interface 1180, shown in FIG. 5, to be displayed.

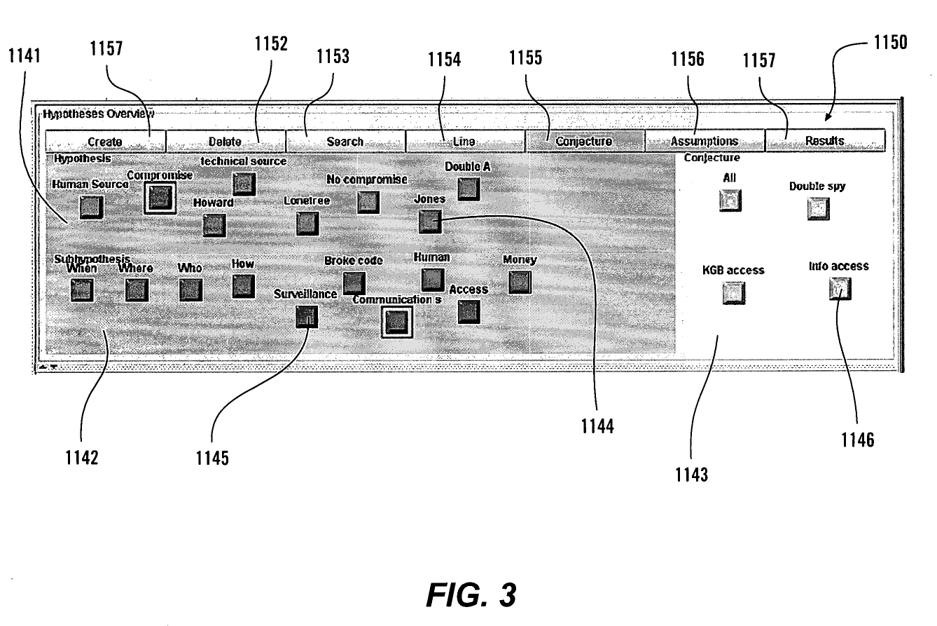

FIG. 3 shows the hypothesis overview portion 1140 in greater detail. It should be appreciated that, in various exemplary embodiments, a particular hypothesis/sub-hypotheses/conjecture can be moved between the hypothesis portion 1141, the sub-hypothesis portion 1142 and/or the conjecture portion 1143 by dragging and dropping that particular element in the desired portion, converting it, respectively, into a hypothesis 1144, a sub-hypothesis 1145, or a conjecture 1146. To change a conjecture 1146 to a hypothesis 1144, the user merely needs to select that conjecture 1146, and drag it from the conjecture portion 1143 to the hypothesis portion 1141. Likewise, to convert a hypothesis 1144 to a sub-hypothesis 1145 or vice versa, the user merely needs to select the desired hypothesis 1144 or sub-hypothesis 1145 and drag it using the mouse to the other of the sub-hypothesis or hypothesis portions 1142 or 1141.

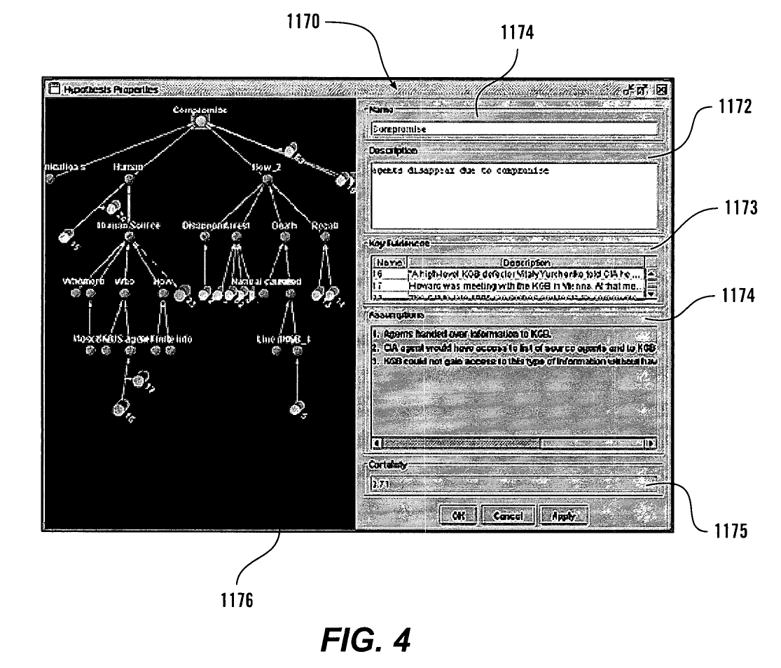

FIG. 4 shows one exemplary embodiment of a hypothesis properties graphical user interface 1170. In various exemplary embodiments, this hypothesis properties graphical user interface 1170 is obtained by right clicking on a hypothesis that is currently displayed in the hypothesis overview portion 1140. For example, as shown in FIG. 3, the compromise hypothesis 1144 has been selected. By right clicking on the compromise hypothesis 1144 shown in FIG. 3, the hypothesis properties graphical user interface 1170 for the compromise hypothesis 1144 is displayed.

As shown in FIG. 4, the hypothesis properties graphical user interface 1170 includes a name portion 1170, a description portion 1172, a key evidence portion 1173, an assumption portion 1174, a score or certainty portion 1175 and an argument visualization portion 1176. The argument visualization portion 1176 displays the argument that has been created that includes the selected hypotheses 1144 or sub-hypotheses 1145. An argument has been created with the compromise hypothesis 1144 as the base or root node of that argument. The intro argument containing this hypothesis is shown in the argument visualization portion 1176. The name portion 1171 shows the name, “compromise”, for this hypothesis 1144. The name for this hypothesis 1144 can be changed by replacing the text in the name portion 1170 and selecting the ok button. The description portion 1172 provides a short, or even a long, description, depending on the user's desire, about the particular selected hypothesis 1144. The key evidence portion 1173 shows the various evidentiary facts displayed in the argument display portion 1176 that have been selected by the user as crucial to the selected hypothesis 1144, either directly or indirectly. Typically, the description portion 1172 of the key evidence portion 1173 contains the same information as the description column shown in FIG. 2.

The assumption portion 1174 shows all of the assumptions that have been made explicit about the selected hypothesis 1144. These assumptions are added by selecting the assumptions widget 1156 shown in FIGS. 1-3. As shown in FIG. 4, three assumptions have been associated with the compromise hypothesis 1144. The certainty portion 1175 displays a score that has been associated with the selected hypothesis 1144 shown in the argument visualization portion 1176 and the name portion 1171.

FIG. 5 shows one exemplary embodiment of an evidence graphical user interface 1180. In various exemplary embodiments, the evidence graphical user interface 1180 is accessed by selecting a particular row of evidence 1127 displayed in, for example, the list visualization 1125 and selecting the properties widget 1118.

As shown in FIG. 5, the evidence graphical user interface 1180 includes a name portion 1181, a description portion 1182, and a number of parameter widgets 1183-1188. In particular, in the exemplary embodiment of the evidence graphical user interface 1180 shown in FIG. 5, the evidence graphical user interface 1180 includes six different evidence parameter widgets. However, it should be appreciated that any number of evidence parameters widgets, from at least 1 to any desired number, can be implemented in the evidence graphical user interface 1180.

In the exemplary embodiment of the evidence graphical user interface 1180 shown in FIG. 5, the six evidence parameters 1183-1188 are divided into source evidence parameters 1183-1185 and applicability evidence parameters 1186-1188. In particular, the source evidence parameters 1183-1185 include a reliability parameter 1183, a proximity parameter 1184 and an appropriateness parameter 1185. The applicability parameters include a plausibility parameter 1186, an expectability parameter 1187 and a support parameter 1188. Each of the parameter widgets 1183-1188 allows a value to be set for that parameter.

In various exemplary embodiments of the evidence graphical user interface 1180, such as that shown in FIG. 5, each of the implemented parameter widget 1183-1188 includes a drop down box associated with the corresponding parameter. Selecting that widget displays the drop down box and allows one of a set of appropriate textual labels, which reflect an analyst's judgment of the likelihood of that parameter, to be selected for that parameter. These textual labels particularly represent the type of language used by the user in judging or grading, for example, the reliability, the proximity, the appropriateness, the plausibility, the expectability, or the support of a particular evidentiary fact. For example, as shown in FIG. 5, for the plausibility parameter, the textual labels are “not very”, “questionable”, “moderately”, very likely”, or “definite”.

It should be appreciated that each of these selectable textual values implemented in a drop down box associated with a particular widget has a numerical value between 0.01 and 0.99 associated with it. In various other exemplary embodiments, the range can extend between 0 and 1. These numerical values represent the numerical probability associated with the textual label. For example, the textual label “not very” will likely have a value between 0.01 and 0.10, for example. In contrast, the textual label “definite”, will likely have a value of between 0.85 and 0.99. It should be appreciated that each drop down box could have a different set of textual labels and that each drop down box could, and typically will, have different values associated with the particular labels. In various exemplary embodiments, the values can be assigned by dividing the range between 0.01 and 0.99 into a number of sub sections equal to the number of choices provided in a particular drop down box. In differing exemplary embodiments, the value associated with each textual label could be the minimum value of that range, the maximum value of that range, the average value of that range, the median value of that range, or any other statistical value associated with that range. In one such exemplary embodiment, the values associated with the plausibility textual labels could be, for example, 0.1, 0.3, 0.5, 0.7 and 0.9 for the textual labels “not very close”, “questionable”, “moderately”, “very likely”, and “definite”, respectively.

In contrast, in various other exemplary embodiments, the values associated with each of the textual labels provided in a given drop down box can be specifically selected to best represent the value that the average analyst places on that particular textual label. Thus, in practice, in such a situation, two labels, such as, for example, “not likely” and “questionable” may be separated by only 0.03, while two labels such as, for example, “moderately” and “very likely” might be separated by 0.25 or more.

Once each of the implemented parameters has a particular textual label or numerical value selected for it, depending upon the particular implementation, a overall value for the source credibility and the overall applicable of the evidentiary fact is generated based on the parameters associated with the source, such as reliability, proximity and appropriateness, while an applicability score is generated based on the values associated with the plausibility, expectability and support parameters. Alternatively, all of the parameters can be combined into a simple credibility value.

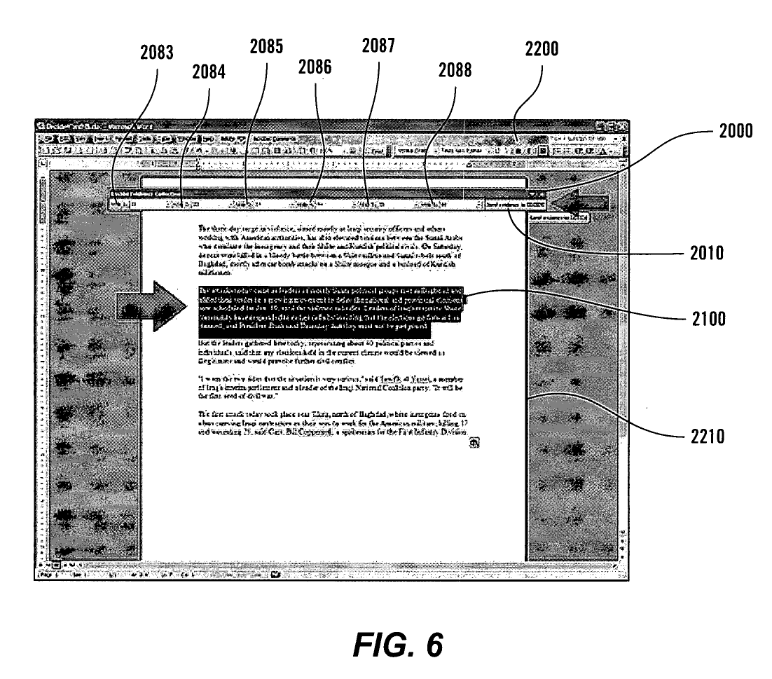

FIG. 6 shows one exemplary embodiment for ingesting a new fact and for assigning values to evidentiary parameters associated with that new fact. In the exemplary embodiment shown in FIG. 6, the evidentiary fact is a section of text from a document that is being viewed using a standard word processing program. In various exemplary embodiments of the systems and methods for visualizing arguments according to this invention, the tool bars of this standard word processing program are augmented to include an evidence collection tool bar or other graphical user interface widget 2000 that can be displayed as part of the graphical user interface 2200 of the word processing program.

When a document 2210 is displayed in the graphical user interface 2200 of the word processing program, a portion 2100 of that document can be selected as a fact to be supplied to the systems and methods for visualizing arguments according to this invention. After opening the tool bar 2000 and selecting the section of text 2100, the tool bar 2000 can be used to provide values for various evidentiary parameters 2183-2188 that correspond to the evidentiary parameters 1183-1188 discussed above with respect to FIG. 5.

In the exemplary embodiment shown in FIG. 6, rather than having drop-down boxes with textual labels that can be selected, the parameters 2183-2188 take direct numerical values ranging from 0.01 to 0.99. In the exemplary embodiment shown in FIG. 6, these numbers are entered by putting in numbers from 1 to 99, with the input numbers being divided by 100 to convert them to values between 0.01 and 0.99. Once the section of the text 2100 is selected and values for each of the attributes or evidentiary parameters 2183-2188 are provided, clicking on the “send evidence” button 2010 extracts the text portion 2100 from the document 2210 and provides it as a new fact to an exemplary argument visualizing system according to this invention. Thus, the tool bar 2000 allows for new facts to be provided or ingested by various exemplary embodiments of systems for visualizing arguments according to this invention using a cut-and-paste technique.

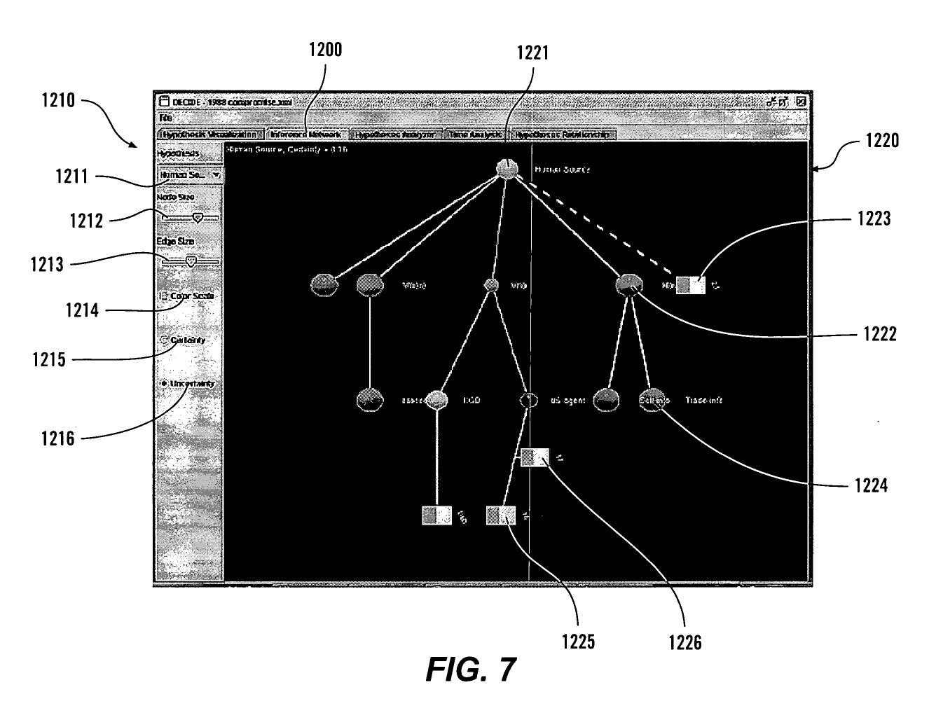

FIG. 7 shows one exemplary embodiment of the argument visualization tab 1200 shown in FIG. 1. As shown in FIG. 7, the argument visualization tab 1200 includes a visualization parameters portion 1210 and an argument visualization portion 1220. As shown in FIG. 7, the visualization parameters portion 1210 includes an argument view selection widget 1211, a node-size widget 1212, an edge-size widget 1213, a color scale widget 1214, a certainty selection widget 1215 and an uncertainty selection widget 1216. The argument view selection widget 1211 allows the user to select how many different arguments to display, and which arguments to display. In the first exemplary embodiment of the argument tab 1200 shown in FIG. 7, the argument view selection widget 1211 has been used to select a single argument. Accordingly, the argument view selection widget 1211 indicates the name of the argument being displayed.

The node-size widget 1212 and the edge-size widget 1213 allow the sizes of the nodes and the edges to be scaled based on the credibility and relevance values associated with an inference link linking an evidentiary fact 1121 to a hypothesis 1144 or sub-hypothesis 1145 or the inferential strength of an inference that extends from a sub-hypothesis 1145 to another sub-hypothesis 1145 or to the main hypothesis 1144. When the node-size widget 1212 or the edge-size widget 1213 is at the left edge, the node and edge size is completely independent of the credibility or inference score for that node or edge. In contrast, when the node-size and edge-size widgets 1212 and 1213 are at the full right hand edge, the size of the nodes and edges are solely functions of the associated scores.

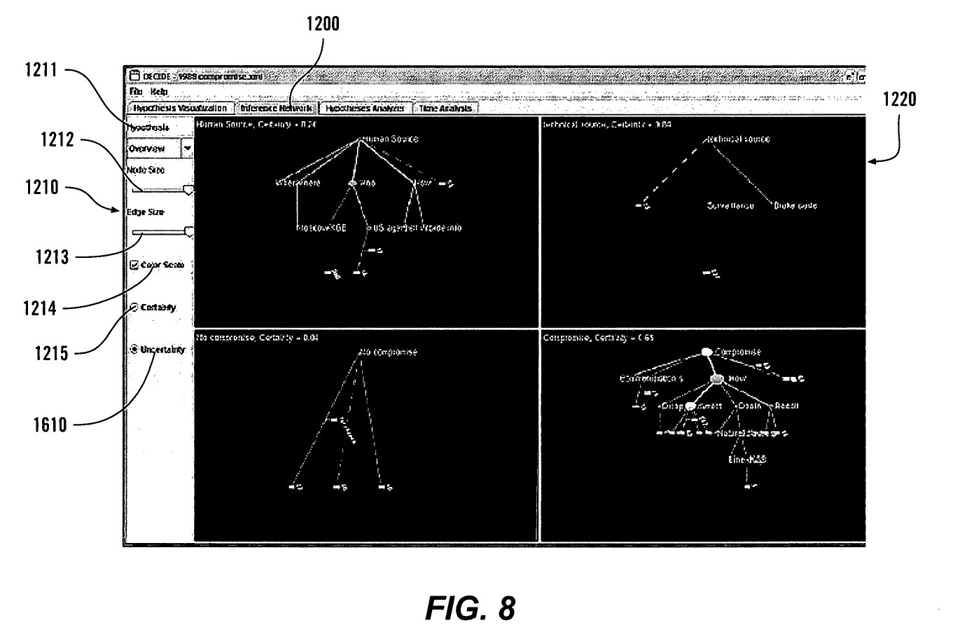

In various exemplary embodiments, as shown in FIG. 8, the argument visualization portion 1220 can display two or more argument visualizations. The second exemplary embodiment of the argument visualization portion 1220 shown in FIG. 8 illustrates that, in addition to allowing the user to view a single argument, as shown in FIG. 7, in various exemplary embodiments, the argument visualization portion 1220 also enables the user to view two or more arguments in a tiled fashion. In the second exemplary embodiment of the argument visualization portion 1220, the argument view selection widget 1211 has been used to select an argument overview view. Accordingly, the argument view selection widget 1211 indicates that the argument overview is being displayed. Using the argument overview view, the analyst can compare various ones of the argument trees against each other. Thus, it should be appreciated that, in various exemplary embodiments of the argument visualization tab 1200, any combination of one, two or more arguments can be selected and displayed for comparison viewing in the argument visualization portion 1220.

The color scale widget 1214, if checked, scales the color based on the user's preference. Finally, the certainty and uncertainty selection widgets 1215 and 1216 allow the scoring of the visualized argument to be switched between an uncertainty value and a certainty value.

As shown in FIGS. 7 and 8, the argument visualization portion 1220 includes some or all of a base or primary hypothesis 1221, a plurality of facts and evidence 1223 that are inferentially relevant to the main or base hypothesis 1221, a plurality of sub-hypotheses 1222 that are inferentially relevant to the main hypothesis 1221, a plurality of sub-sub-hypotheses 1224 that are inferentially relevant to various ones of the sub-hypotheses 1222, a number of facts and evidence 1225 that are inferentially relevant to various ones of the sub-sub-hypotheses 1224, at least one evidentiary fact 1226 that supports some other fact in evidence 1225, as well as a score 1227 that indicates the certainty or uncertainty score, depending upon which selection widget 1215 or 1216 has been selected for the main or base hypothesis 1221. As shown in FIGS. 7 and 8, the inferences, presented between the links by the evidence, the sub-hypotheses, the sub-sub-hypotheses, and the main hypothesis can be solid, representing supportive relationships, or broken, representing contradictory relationships.

FIG. 9 shows one exemplary embodiment of a hypothesis assumption graphical user interface 1600. As indicated above, the hypothesis assumption graphical user interface 1600 can be accessed by right clicking on one of the hypotheses 1144 or sub-hypotheses 1145 shown in the hypothesis overview portion 1140 or the argument visualization portion 1160. As shown in FIG. 9, in various exemplary embodiments, the hypothesis assumption graphical user interface 1600 includes a name portion 1610, and assumption portion 1620, and a key evidence portion 1630.

In various exemplary embodiments, the name portion 1610 displays the current name of the selected hypothesis 1144, sub-hypothesis 1145 or conjecture 1146. The assumptions portion 1620 includes an add/edit assumption portion 1622, a previously defined assumption portion 1624, and add action widget 1626 and a remove action widget 1628. As shown in FIG. 9, in this exemplary embodiment of the hypothesis assumptions graphical user interface 1600, three assumptions have previously been defined, and thus are shown in the defined assumptions portion 1624. A fourth assumption is displayed in the add/edit portion 1622 and is being either added or edited. Once the user has finished adding a new assumption or editing a selected previously added assumption, clicking on the add action widget 1626 saves the assumption being added or edited using the add/edit portion 1622 into the previously added portion 1624 as a currently defined assumption.

In contrast, if the user wishes to delete a previously added assumption, the user can highlight one of the previously added assumptions shown in the previously defined portion 1624 and can click on the remove action button 1628. If the user merely wishes to edit one of the previously added assumptions, double clicking on that assumption will bring it up in the add/edit portion 1622.

In the exemplary embodiment of the hypothesis assumptions graphical user interface 1600 shown in FIG. 9, the key evidence portion 1630 displays any facts that are directly inferentially linked to the selected hypothesis and thus form key evidence for or against that hypothesis. The key evidence portion 1630 allows the analyst to review the key evidence associated with the selected hypothesis 1144, sub-hypothesis 1145 or conjecture 1146 to allow the user to more efficiently define the assumptions.

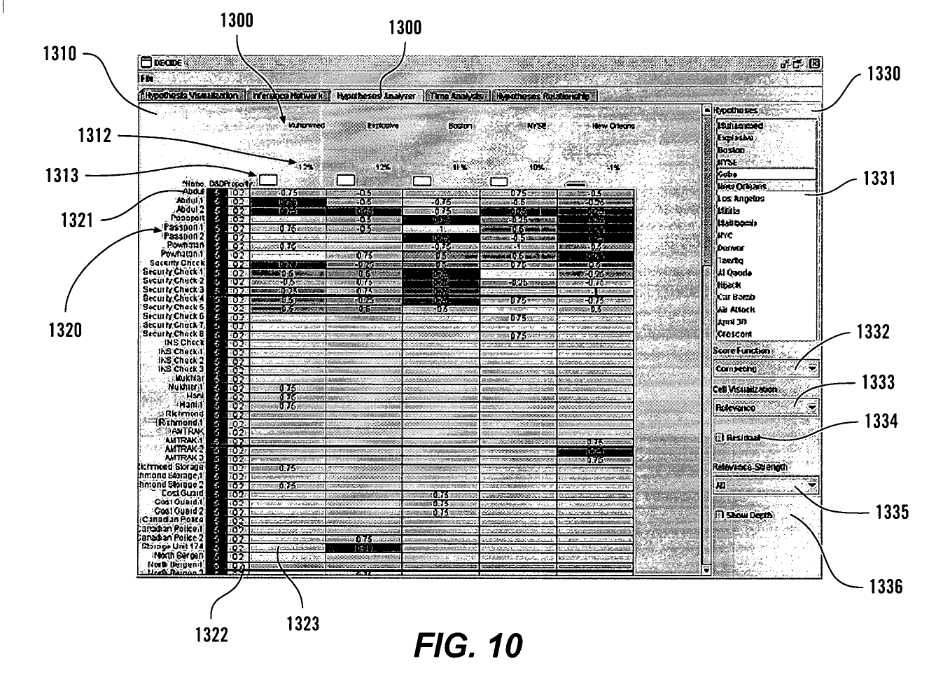

FIG. 10 shows one exemplary embodiment of the hypothesis analyzer tab 1300 of the argument visualization graphical user interface 1000 according to this invention. In particular, the hypothesis analyzer tab 1300 shows one exemplary embodiment of an evidence marshalling tool. In particular, the particular evidence marshalling tool implemented in this exemplary embodiment of the hypothesis analyzer tab 1300 is based on the “Analysis of Competing Hypotheses” technique described in Psychology of Intelligence Analysis by R. J. Heuer, Central Intelligence Agency (1999), incorporated herein by reference in its entirety. Heuer's “Analysis of Competing Hypotheses” (“ACH”) is a technique for marshalling evidence, developing alternative hypotheses and associating evidence with various hypotheses. As shown in FIG. 10, in various exemplary embodiments, the ACH marshalling tool implemented in the hypothesis analyzer tab 1300 includes a selected hypothesis region 1310, a fact element region 1320 and a control region 1330. As shown in FIG. 10, the particular exemplary embodiment of the visualization of the ACH implemented in various exemplary embodiments of the hypothesis analyzer 1300 displays the fact items in the fact element portion 1320 as a series of rows, with each separate fact item associated with a separate row. At the same time, a number of selected hypotheses are displayed in the selected hypothesis portion 1310, defining columns within the fact element portion 1320.

In various exemplary embodiments, the selected hypothesis region 1310 is divided into a number of sub-regions equal to the number of selected hypotheses, with one selected hypothesis associated with each sub-region. For each selected hypothesis, the name 1311 of that selected hypothesis, a score value 1312 for that selected hypothesis, and a scoring bar graph 1313 for that selected hypothesis is displayed in the sub-region associated with that selected hypothesis. The score value 1312 provides a numerical indication of the certainty or likelihood that that hypothesis is correct, while the bar graph 1313 provides a graphical or visual representation of the score of that hypothesis. It should be appreciated that this score can be determined using Bayesian, Dempster-Schaeffer, Baconian or other probabilistic methods.

As shown in FIG. 10, in the fact element region 1320, each separate fact item 1321 is associated with a separate row. Each row is divided into a number of hypothesis columns 1323 and a number of ancillary columns 1322. The number of hypothesis columns 1323 is equal to the number of selected hypotheses displayed in the selected hypothesis region 1310. The one or more ancillary columns 1322 are used to display various bits of ancillary information, such as the credibility score for that fact element or the likelihood that a particular fact item may be the result of a denial and/or deception (D&D) campaign. That is, if the fact item is easily spoofed, the fact item may be a false fact planted by a party wishing it to mislead the analyst. In such case, the value in the “D&D” column will be low, such as 1 or 2. In contrast, if the fact item is not easily falsely created, the “D&D” score will be relatively high, such as 9 or 10. Other columns, such as the “property column”, which shows the credibility score for the fact elements 1321, may be included in the ancillary columns 1322.

For each of the hypothesis columns 1323 for a given fact item 1321, if that fact item has not been associated with the corresponding hypothesis for that hypothesis column 1323, then the cell for that fact item row and that hypothesis column is left blank. Otherwise, if that fact item 1321 has been associated by an inferential link either directly or indirectly with the hypothesis, making it an evidentiary fact with respect to that hypothesis, that cell will display one or more pieces of information based on a control selection made using the control portion 1330.

As shown in FIG. 10, the control portion 1330 includes a hypothesis selection portion 1331, a score function selection widget 1332, a cell visualization widget 1333, a residual check box widget 1334, a relevance/strength selection widget 1335, and a depth display widget 1336. In various exemplary embodiments, the hypothesis selection widget 1331 includes a display of all currently active hypotheses 1144 and sub-hypotheses 1145. In various exemplary embodiments, clicking on the region within the hypothesis selection widget 1331 associated with one of the displayed hypotheses 1144 or 1145 toggles that hypothesis 1144 or 1145 between a selected state and a deselected state. In various exemplary embodiments, when a hypothesis 1144 or 1145 in the hypothesis selection widget 1331 is selected, it is displayed in a color that differentiates the selected hypotheses from the d-selected hypotheses.

When a hypothesis 1144 or 1145 is in the selected state, such as for the hypotheses “Mohammed,” “Explosive,” “Boston,” “NYSE,” or “New Orleans,” that hypothesis is added in a new sub-region to the selected hypothesis region 1310, such that its name, its score value and a corresponding bar graph are displayed. When a particular hypothesis 1144 or 1145 displayed in the hypothesis selection widget 1331 is deselected, it is removed from the selected hypothesis region 1310 and its column in the fact element table 1320 is removed from the display.

It should be appreciated that, in various exemplary embodiments, adding newly selected hypotheses 1144 or 1145 or removing newly deselected hypotheses 1144 or 1145 causes the widths of the hypotheses columns for the selected hypotheses to change. In various other exemplary embodiments, each of the selected hypotheses columns has a fixed column width. In this case, if adding additional selected hypotheses causes the overall width of the selected hypothesis region 1310 and the fact element table 1320 to be wider than the available display area, a horizontal scroll bar is implemented for at least the sub regions of the selected hypothesis region 1310 and the corresponding hypothesis columns 1323.

In various exemplary embodiments, the score function widget 1332 allows the user to select between at least two different scoring functions. In various exemplary embodiments, these at least two different scoring functions include at least a Competing Hypotheses scoring function and a Multiple Hypotheses scoring function. When the Multiple Hypotheses scoring function is selected, any number of hypotheses can receive a high score. Accordingly, each of the hypotheses is scored between 0 and 1, based on its overall likelihood of being correct, independent of the scores associated with any of the other selected hypotheses.

When the Competing Hypotheses scoring function is selected, as shown in FIG. 10, the scores assigned to each of the selected hypotheses are determined relative to each other, so that the sum of the various scores associated with each of the selected hypotheses totals exactly to 1 when all of the evidence has been associated with all of the hypotheses.

In various other exemplary embodiments, the sum of the values associated with each of the selected hypotheses represents the likelihood that at least one of these selected hypotheses is right. This allows analysts to determine if other hypotheses should be considered. For example, when the sum of the scores associated with the selected hypotheses is less than 50%, a residual hypothesis or alternative explanation is probable and reflected with the remaining evidence, which has not been associated, being associated with a “residual” hypothesis. This situation is shown in the exemplary embodiment shown in FIG. 10, where the sum of the scores associated with the selected hypotheses is 0.44.

When the cell visualization widget 1333 is selected, a drop down box is displayed that allows the user to select the particular information to be displayed in each of the hypotheses columns 1323 of the fact element table 1320. In the exemplary embodiment shown in FIG. 10, the user has selected the relevance data item for the cell visualization widget 1338. Accordingly, each of the cells in the hypotheses columns 1323 display the relevance assigned to a particular evidence item relative to a particular hypothesis. Other potential visualization data items include credibility, inferential strength, which is a function of both credibility and relevance, “strength and relevance” which causes a split cell to be displayed that display relevance on one half and inferential strength on the other half or any other desired data element that is available with respect to the fact elements 1321 and is differentiated between various ones of the hypotheses shown in the hypothesis selection widget 1331. When checked, the residual check box 1334 causes the remaining evidence that has not been associated with any hypothesis to appear. This leads the analyst to double check arguments and evidence and possibly brainstorm further alternative explanations.

The relevance-strength selection widget 1335 includes a drop down box that allows the user to select whether all relevant items are displayed, only cells having positive values, corresponding to fact items that support the corresponding hypothesis, or cells having negative value, corresponding to fact items that tend to disprove or contradict the corresponding hypothesis.

When the show depth check box 1336 is checked, each of the cells in the hypothesis columns 1323 additionally shows the depth at which that fact item 1321 is connected, either directly or indirectly to the corresponding hypothesis. For example, if a fact item is directly connected to the corresponding hypothesis, its depth level is one. In contrast, if that fact item is connected to a sub-hypothesis, which is connected to that hypothesis, then the depth is two, and so on.

In the exemplary embodiment shown in FIG. 10, because the relevance data has been selected in the cell visualization widget 1333, each of the cells of the hypothesis columns 1323 that correspond to a fact item that has been inferentially linked to a particular hypothesis displays the relevance value that some analyst has associated with that inference link. Each of these cells is then color-coded based on the absolute value of that relevance score. Additionally, each of the relevance scores indicates whether the relevance is such that the fact item supports the hypothesis by showing a positive value or contradicts the hypothesis, by showing a negative value.

It should be appreciated that, unlike the credibility score, in the exemplary embodiment shown in FIG. 10, the analyst directly assigns one of a number of predetermined relevance values, such as 1.0, 0.75, 0.5 and 0.25 for each cell that corresponds to an inferential like between one of the fact items 1321 and one of these selected hypotheses, and directly assigns a positive or negative value to that number. Thus, the values for the relevance range between −1.0 and +1.0. As shown in FIG. 10, such as for the fact items “Abdul 1” “Muktar” and “Hani”, a particular fact item 1321 can be associated with 0, 1, more than 1, or all of the selected hypotheses. When a particular fact item 1321 is not associated with a particular hypothesis, no data is displayed in the corresponding cell. It is should be appreciated that this is equivalent to a particular fact item 1321 having a relevance of 0 with respect to that particular hypothesis.

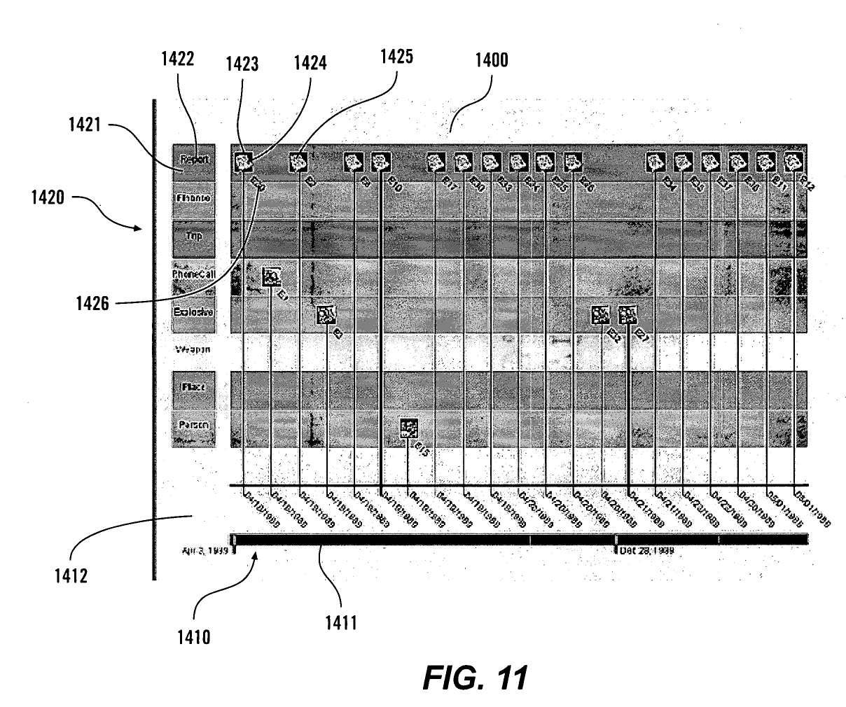

FIG. 11 shows one exemplary embodiment of the time analysis tab 1400 of the argument visualization graphical user interface 1000 according to this invention. As shown in FIG. 11, in various exemplary embodiments, the time analysis tab 1400 displays a timeline visualization comprising a timeline visualization portion 1410 and an event visualization portion 1420. This timeline analysis tab 1400 allows selected fact items to be related to each other in time. As shown in FIG. 11, the timeline visualization portion 1410 includes a time frame selection widget 1411 and a date display portion 1412. The time frame selection widget 1411 allows a time frame to be set that can be used to select a sub-set of the fact items that occur within the time frame selected using the time frame selection widget 1411. The time display portion 1412 then displays the date and/or time information associated with each fact element that occurred within the time frame selected using the time frame selection widget 1411.

As shown in FIG. 11, if the number of selected fact items that occur within the selected time frame cannot all be displayed in the event visualization portion 1420, a horizontal scroll bar can be used to scroll at least the fact items 1422 left and right. The event visualization portion 1420 includes an event class display portion 1421 comprising a number of different event classes 1422 and an event display portion 1423 that displays each event item 1424 that occurs within the selected time frame, using an icon 1425 identifying the event class and a fact name 1426 identifying the particular event. As shown in FIG. 11, in various exemplary embodiments, each of the event classes 1422 displaying an event class 1421 has a different color associated with it. Likewise, each of the event icons 1425 displayed for a particular event depends on which event class that event item has been put into by the analyst.

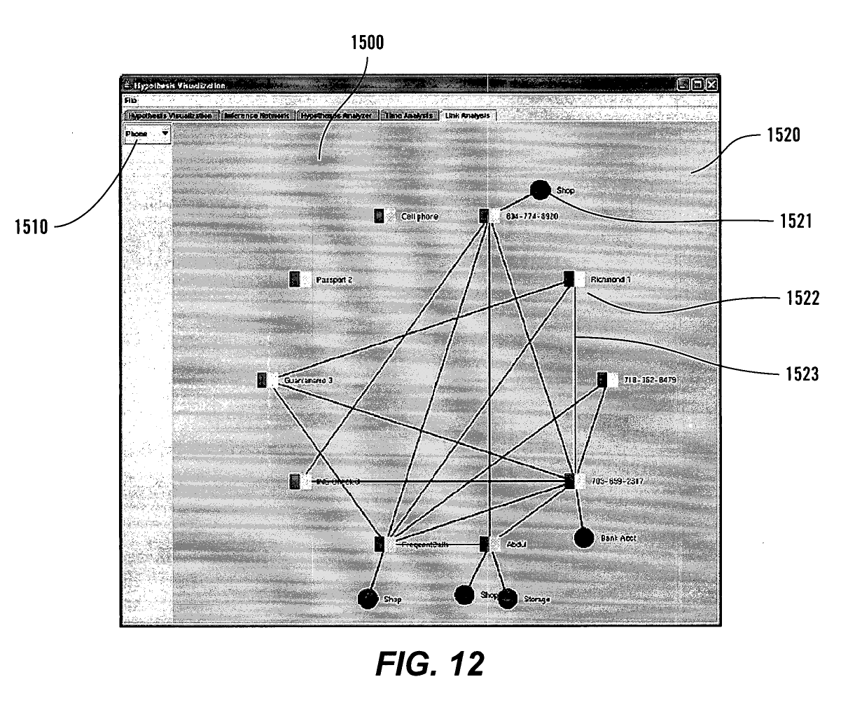

FIG. 12 shows one exemplary embodiment of the link analysis tab 1500 of the argument visualization graphical user interface 1000 according to this invention. As shown in FIG. 12, in various exemplary embodiments, the link analysis tab 1500 includes a link analysis visualization 1520 and a link parameter selection widget 1510. The link parameter selection widget 1510 allows the user to select a particular linking parameter that links various fact items to each other. Such linking parameters can be telephone calls between various actors, locations, cell phones, telephone numbers and the like, such as shown in the link analysis visualization portion 1520 of FIG. 12, visits by various actors to the same addresses, to the same meetings, and/or the same other actors, or the like.

In each case, the link analysis visualization 1520 includes a plurality of facts 1522, links 1523 between various ones of the facts 1522, and other sets of facts 1521 that the facts 1522 may have been linked to. In the particular set of linkages visualized in the particular exemplary embodiment of the link analysis visualization 1520 shown in FIG. 12, the set of linkages being visualized are phone calls made between various phones, cell phones, locations and parties based on analyses of phone records. A fact item is created for each different phone number, person, location, cell phone, and the like. When the phone records for each of these parties are analyzed, it can be determined, for example, that a phone call was made from the phone identified as “703-659-2317” to the phone number identified as “716-352-8479.” Accordingly, a link 1523 is created between these two phone numbers. Using this link analysis, the analyst can determine, for example, which phone numbers were called by which other phone numbers, which locations spoke to which other locations, which parties spoke to which other parties, and the like. This link analysis visualization 1520 allows the analyst to determine which facts are relevant to each other and which hypotheses the facts are or may be relevant to.

As discussed above, in the link analysis visualization 1520 shown in FIG. 12, double clicking on a fact that is currently displayed in the link analysis visualization 1520 causes a browser window to open that displays the source document or other source material that the fact was obtained from. Right clicking on that fact causes the evidence graphical user interface 1180, shown in FIG. 5, to be displayed. In various exemplary embodiments, the evidence is added by selecting a fact 1522 or a related fact set 1521 displayed in the link analysis visualization 1520 and dragging and dropping the selected fact from the link analysis visualization 1520 to the desired location in the argument being constructed or edited using the argument construction portion 1160.

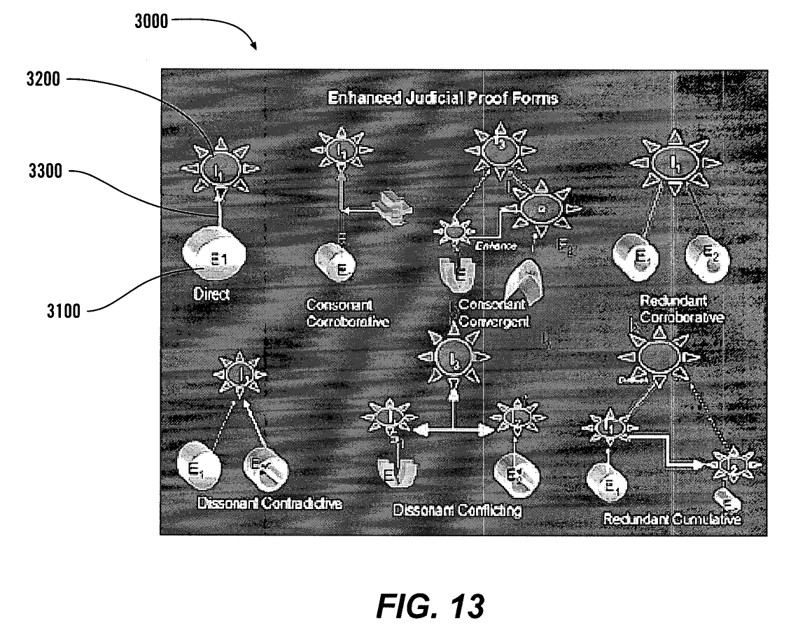

FIG. 13 illustrates a number of enhanced judicial proof forms 3000 that can be used to create Wigmorean-type arguments. As shown in FIG. 13, the enhanced judicial proof forms 3000 are used to illustrate how an evidentiary fact 3100 is inferentially linked to a hypothesis 3200 by an inferential link or inference 3300. As shown in FIG. 13, an evidentiary fact 3100 can be directly linked to a hypothesis 3200. Alternatively, an evidentiary fact 3100 can be linked to the inference 3300 that directly links another evidentiary fact 3100 to an hypothesis 3200 to provide consonant or supportive corroboration of that inferential link 3300. Moreover, when two evidentiary fact items each directly support a sub-hypothesis 3200, and those sub-hypotheses 3200 directly support a main hypothesis 3200, then those two evidentiary facts are referred to as continent convergent facts. Alternatively, when two evidentiary facts 3100 both directly support the same hypothesis, those evidentiary facts are referred to as being redundantly corroborative facts.

In contrast, to situations where the multiple evidentiary items both support or both disprove a particular hypothesis, when two evidentiary items 3100 are directly connected to a hypothesis, but one supports it while the other tends to disprove it, those evidentiary items are referred to as dissidently contradictive facts. When two evidentiary items 3100 each directly support different sub-hypotheses, but one sub-hypothesis supports a main hypothesis but the other sub-hypothesis tends to disprove the main hypothesis, the evidentiary facts are referred to as dissidently conflicting facts. Finally, when a first evidentiary fact supports a sub-sub-hypothesis and that sub-hypothesis and another evidentiary fact both support a sub-hypothesis, while both of the sub-sub-hypothesis and the sub-hypothesis also directly support a main hypothesis, those evidentiary facts are referred to as redundantly cumulative facts. Based on these enhanced judicial proof forms, analysts can easily create Wigmorean diagrams such as those shown in FIGS. 1 and 2.

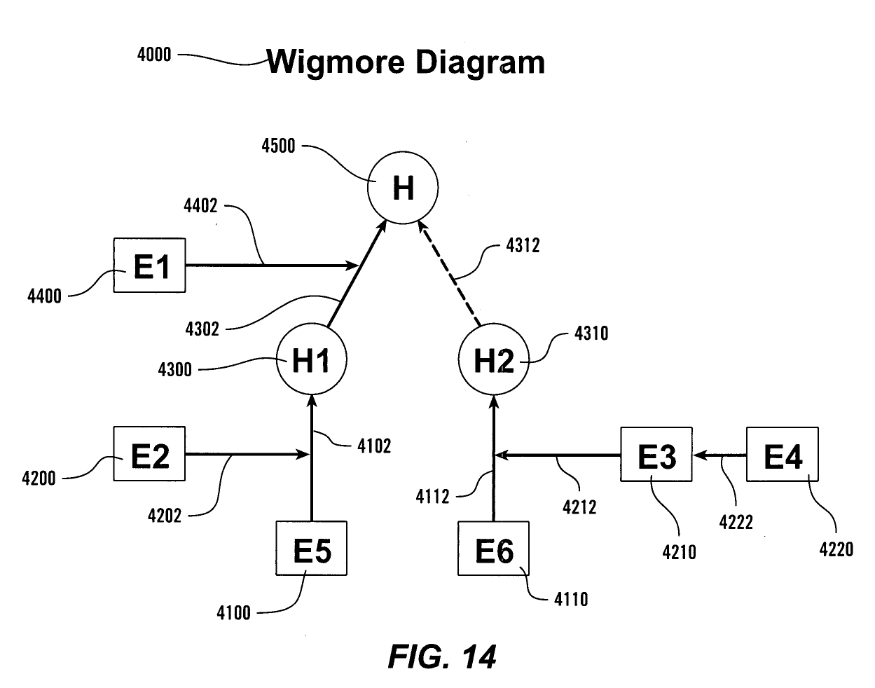

FIG. 14 shows one exemplary embodiment of a Wigmorean diagram 4000. As shown in FIG. 14, the Wigmorean diagram 4000 includes a plurality of base evidentiary facts 4100 and 4110 that are linked by evidentiary links 4102 and 4112 respectively, to sub-hypotheses 4300 and 4310. Moreover, a consonant corroborative evidentiary fact 4200 is linked by an inference 4202 to the inference 4102. Similarly, a consonant corroborative evidentiary fact 4210 is inferentially linked by an inference 4212 to the inference 4112, while a second level consonant corroborative fact 4220 is linked by an inference 4222 to the continent corroborative evidentiary fact 4210.

Each of the sub-hypotheses 4300 and 4310 is linked by an inferential link 4302 and 4312, respectively, to a main hypothesis 4500. As shown in FIG. 14, while each of the inferences 4102, 4112, 4202, 4212, 4222, and 4302 is a positive or supporting inference, the inference 4312 is a contradictory or disproving inference. Finally, as shown in FIG. 14, the continent corroborative evidentiary fact 4400 is linked by inference 4402 to the inference 4302.

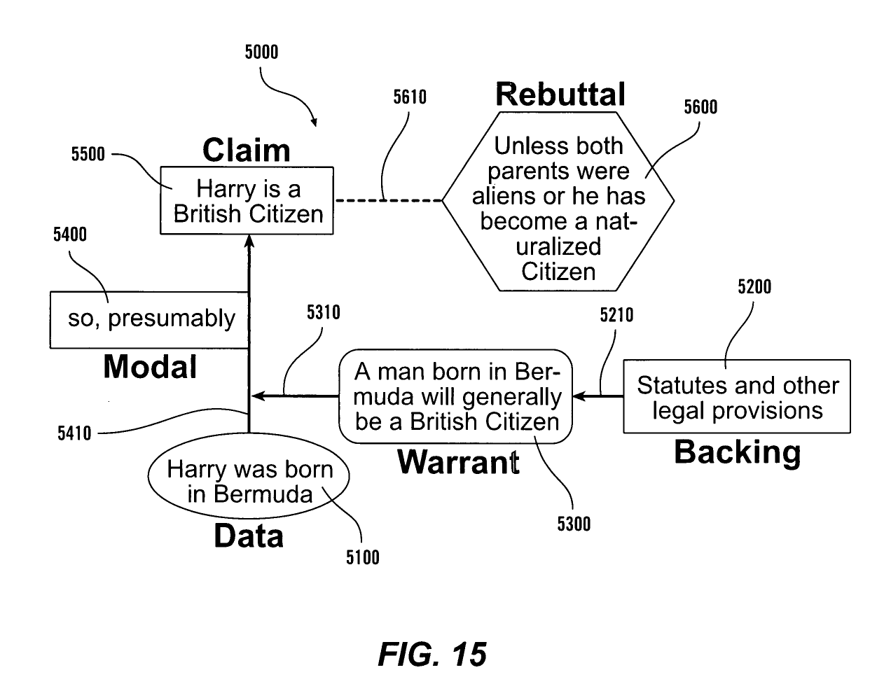

FIG. 15 illustrates one exemplary embodiment of a Toulminian data form 5000. As shown in FIG. 15, a base data element or evidentiary fact 5100 is linked by an inference 5410 to a claim or hypothesis 5500. In the example shown in FIG. 15, the data item is “Harry was born in Bermuda”, while the claim or hypothesis is “Harry is a British citizen”. A warrant 5300 is linked by an inferential link 5310 to the inferential link 5410, while a backing 5200 is linked by an inferential link 5210 to the warrant 5300. The warrant is generally a supporting fact that provides a basis for asserting that the inference 5410 is correct. In the example shown in FIG. 15, the warrant is “A man born in Bermuda will generally be a British citizen”, and provides the evidentiary support for the inferential link that the data “Harry was born in Bermuda”, supports the hypothesis that “Harry is a British citizen”. The backing 5300 provides the support for asserting that the warrant is in fact true. The modal 5400 defines the degree of certainty of inference represented by the inferential link 5410.

Also connected to the claim or hypothesis 5500 that “Harry is a British citizen,” is a rebuttal 5600 connected to the claim or hypothesis 5500 by a contradictory inferential link 5610. In the exemplary embodiment shown in FIG. 15, the rebuttal provides bases for asserting that, even though the data element “Harry was born in Bermuda,” may be true, the conclusion “Harry is a British citizen,” may not be. In this case, the rebuttal states that Harry will not be a British citizen if both parents were citizens of other countries or Harry has subsequently become a naturalized citizen of another country. That is, if either or both of these rebuttal situations are true, even though the data element 5100 is true, the rebuttal 5600 strongly disproves the hypothesis or claim 5500 that “Harry is a British citizen.”

As outlined above, in various exemplary embodiments, the argument visualization systems and methods according to this invention use Bayesian probabilistic methods to score the various different hypotheses based on the arguments built around those hypotheses. In various exemplary embodiments, the evidence credibility and hypothesis uncertainty is modeled using a scale from 0.0 to 1.0 that roughly corresponds to a probability value. In general, the inferential strength of an inference extending from an item of evidence to a hypothesis or sub-hypothesis is then the product of the relevance of that evidence to that hypothesis times the credibility of that evidence. The strength or inferential force of an inference thus indicates how strongly the evidence supports the hypothesis. The sign on the relevance and thus the direction of that evidence, i.e., whether it supports or contradicts the hypothesis, determines whether the inferential strength is positive or negative.

Under the standard rules of Bayesian probabilistic methods, inferences and uncertainty propagate a long chain of inferences using standard rules of conditional probability. For example, the certainty or probability of a sub-hypothesis H₁, represented as P(H1|E1), in view of an evidentiary fact E₁, is:
P(H1|E1)=C_{E1}*R_{E1|H1} (1)

C_{E1} is the credibility of an evidentiary fact E₁; and

R_{E1|H1} is the relevance of the evidentiary fact E₁ to the sub-hypothesis H₁.

Then, when the sub-hypothesis H₁ that has multiple pieces of evidence inferentially linked to it, the certainty or probability P(H1|E1,E2) of the hypothesis H₁, in view of two evidentiary facts E₁ and E₂, is:
P(H1|E1,E2)=C_{E1}*R_{E1|H1}+C_{E2}*R_{E2|H1}−C_{E1}*R_{E1|H1}*C_{E2}*R_{E2|H1}; (2)
where:

C_{E2} is the credibility of the second evidentiary fact E₂ that is inferentially linked to the sub-hypothesis H₁; and

R_{E2|H1} is the relevance of the evidentiary fact E₂ to the sub-hypothesis H₂.

It should be appreciated that this is simply the conditional probability that the sub-hypothesis H₁ is true given that the various inferentially-linked evidentiary facts such as, for example, E₁ and E₂, are independent of each other. Of course, it should be appreciated that if the evidentiary facts are not independent of each other, or more accurate solutions are desired, more sophisticated Bayesian, Dempster-Schaeffer, Baconian or other probabilistic methods can be used.

In probabilistic terms, the relevance R_{X|Y} encodes the conditional probability that the hypothesis X is justified given that the evidentiary fact or sub-hypothesis Y is true. For an inference chain through a plurality of sub-hypotheses, the certainty of the hypothesis is equal to the product of the credibility of the underlying evidentiary fact multiplied by the relevance of each of the inferential links between that piece of underlying evidentiary fact and the ultimate hypothesis. Thus, if a hypothesis H₂ is inferentially supported by the sub-hypothesis H1, where the inferential link between the sub-hypothesis H₁ and the hypothesis H₂ has a relevance R_{H2|H1}, the certainty P(H2|H1) of the hypothesis H₂ is:
P(H2|H1)=C_{H2}*R_{H1|H2}=C_{E1}*R_{E1|H1}*R_{H1|H2} (3)

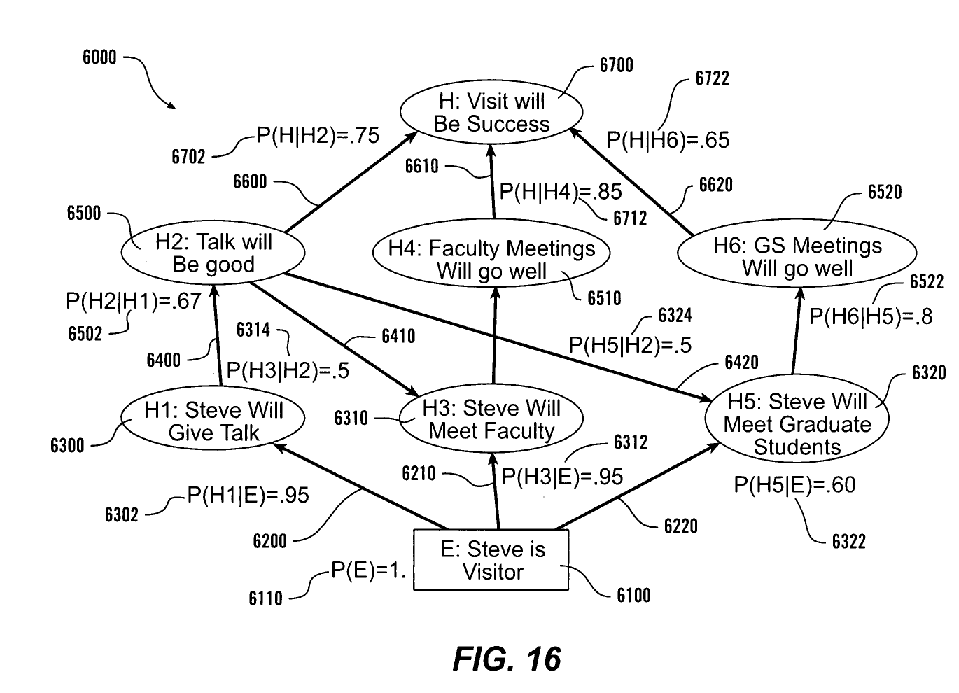

FIG. 16 illustrates an underlying evidentiary fact and a series of hypotheses inferentially linked into an argument regarding that evidentiary fact. As shown in FIG. 16, the evidentiary fact 6100 “Steve is a visitor,” has a credibility defined as P(e)=1, indicating that this fact is 100% credible.

As shown in FIG. 16, three sub-hypotheses H₁, H₃, and H₅, are directly inferentially linked by inferences 6200, 6210 and 6220 to the evidentiary fact 6100. In this exemplary embodiment, the inference 6200 has a relevance of 0.95, while the inferential link 6210 also has a relevance of 0.95 and the inferential link 6220 has a relevance of 0.6. Accordingly, the H1 sub-hypothesis 6300 has a certainty 6302 of P(H₁|E)=0.95 (=1.0*0.95), while the H₃ sub-hypothesis 6310 has a certainty 6312 in view of the evidence E of P(H₃|E)=0.95 (=1.0*0.95) and the H₅ sub-hypothesis 6320 has a certainty 6322 in view of the evidence E of P(H₅|E)=0.6 (=1.0*0.6). The total certainties of the H₃ and H₅ sub-hypotheses 6310 and 6320 cannot yet be determined, because they are also inferentially linked to the H₂ sub-hypothesis 6500.

As shown in FIG. 16, the sub-hypothesis 6500 is inferentially linked by inference 6400 with a relevance of 0.7. Accordingly, the certainty 6402 of the sub-hypothesis 6500 is P(H₂H₁)=0.67(=0.95*70).

The certainties of the H₃ and H₅ sub-hypotheses 6310 and 6320 can then be determined. In particular, the relevance of the inferential link 6600 between the H₂ sub-hypothesis 6500 and the H₃ sub-hypothesis 6310 is 0.75, while the relevance of the inferential link 6610 between the H₂ sub-hypothesis 6500 and the H₅ sub-hypothesis 6320 is also 0.75. Accordingly, the certainties 6314 and 6324 of the sub-hypotheses 6310 and 6320 in view of the sub-hypothesis 6500 is P(H₃₁H₂)=0.5 and P(H₅₁H₂)=0.5. At the same time, as indicated above, the certainties 6312 and 6322 of the sub-hypothesis 6310 in view of the evidentiary fact 6100 are P(H₃|E)0.95 and P(H₃|E)0.6. The total or combined certainty of the sub-hypothesis 6310 is thus P(H₃|H₂,E)=0.975. Similarly, the total certainty 6522 of the H₅ sub-hypothesis 6320 is P(H₅|H₂,E)=0.8. It should be appreciated that the rest of the analysis can be performed by applying equations 1-3 to the remaining inferential links. For the argument or Bayesian belief network shown in FIG. 16, the final score for the H hypothesis 6700 that “Visit will be success,” given the individual certainties 6702, 6712 and 6722 for the hypothesis 6700 based on the inferential links 6600, 6610 and 6620 to the sub-hypotheses 6500, 6510 and 6520 shown in FIG. 16, will be 0.987.

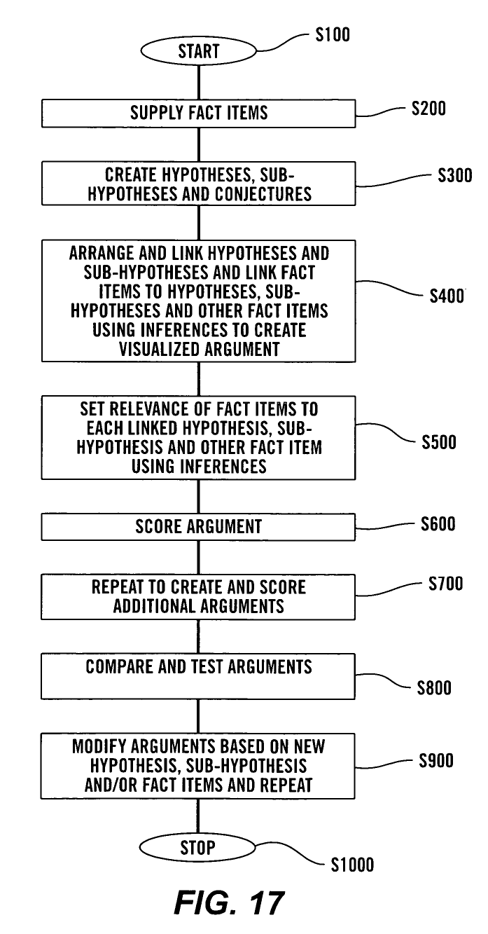

FIG. 17 is a flowchart outlining one exemplary embodiment of a method for visualizing an argument according to this invention. As shown in FIG. 17, beginning in step S100, operation continues to step S200, where a plurality of fact items are supplied to the visualization system. In various exemplary embodiments, each of the facts is entered in by hand using the evidence input graphical user interface 1180 shown in FIG. 5. In various other exemplary embodiments, one or more of the facts are supplied using the evidence extractor widget 2000 shown in FIG. 6. Once a plurality of fact items are supplied in step S200, operation continues to step S300, where a desired number of hypotheses, sub-hypotheses and/or conjectures are created using the hypothesis overview portion 1140 shown in FIGS. 1-3. Operation then continues to step S400.

In step S400, a desired hypothesis and zero, one or more sub-hypotheses are arranged and linked together and a number of the supplied fact items are linked to the selected hypothesis, sub-hypotheses and/or previously linked fact items using inference links to create a visualized argument, as outlined above with respect to FIGS. 1, 2 and 4. Then, in step S500, the relevance of each inferential link between a fact item and the hypothesis, sub-hypotheses, and/or other fact items is set. In various exemplary embodiments, the relevance can be set using the ACH shown as part of the hypothesis analyzer tab 1300, for example, by clicking on a cell in the ACH, which causes a dialog box to be displayed. In various other exemplary embodiments, the relevance of an inferential link can be set by clicking on a visualization of that link, such as in the argument construction portion 1160

Once at least some of the fact items, which become evidentiary facts when linked to various other hypotheses, sub-hypotheses and/or other facts, are provided with credibility scores and the inferential links between the evidentiary facts, the sub-hypotheses and the hypothesis are given relevance values, the argument built around the main hypothesis can be scored to generate a certainty value for that main hypothesis in step S600. Then in step S700, one or both of steps S200 and S300 can be repeated along with steps S400-S600 to create and score one or more additional arguments. Additionally, it should be appreciated that, as additional facts become available and/or the significance of previously underappreciated facts becomes apparent, steps S200, S400 and S500 can be repeated to add such new facts into a current argument, with step S600 being repeated to rescore that argument. Operation of the method then continues on to step S800.

In step S800, one or more of the arguments created in steps S600 and S700 can be compared and scored, either independently or competitively, to compare and test the arguments against themselves and each other. It should be appreciated that the arguments can be compared on any desired basis, such as, for example, which analysts created the arguments, who collaborated on creating the arguments, which organization and/or individual commissioned the argument, the date the argument was created, last modified, or the like. In step S900, the user can modify the visualized argument based on new hypotheses, sub-hypotheses and/or fact items by repeating at least steps S400, S600 and S800 and also by repeating steps S200, S300, S500 and S700 as well. In particular, the analyst will complete various ones of steps S200-S900 until the analyst is satisfied that the analyst has adequately supported a selected hypothesis for building the appropriate argument around it.

While FIG. 17 shows steps S200-S900 being performed in a linear manner, it should be appreciated that, based on the graphical user interfaces shown in FIG. 1-16, that the user can actually jump around and perform steps S200-S900 in any order, and can even partially prepare or perform various ones of these steps, switch to another step, return to the first step, and the like. It should be appreciated that the exemplary embodiment of the method for visualizing arguments outlined in FIG. 17 is not intended to place any limitations on how the various steps are performed either in whole or in part.

It should be appreciated that, in various exemplary embodiments, the argument visualization graphical user interface and methods for visualizing an argument according to this invention can use argument templates that allow an analyst to more easily construct a particular argument. These templates can correspond to the types of problem, such as a criminal investigation, a foreign policy analysis, a military analysis or the like. These templates can also correspond to the type of analysis to be performed, such as a process analysis, an event analysis, a predictive analysis, an explanative analysis, a descriptive analysis, an investigative analysis or the like. It should also be appreciated that a “wizard”-type software element could be used to lead an analyst through at least the initial stages of constructing an argument, or even could be used to at least initially create hypotheses, sub-hypotheses and conjectures, create and/or gather potentially relevant facts, and link them together into at least an initial form of an argument.

It should also be appreciated that, in various exemplary embodiments, the changes, revisions, additions, deletions, and possibly the person making such changes, can be tracked, similarly to the “Track Changes” feature of Microsoft Word™. This allows a user, such as a subsequent analyst, or a decision-maker, to see how a particular argument has changed through time. In various exemplary embodiments, the various tracked changes can be automatically shown in rapid succession, similarly to an animation, that allows the viewer to experience how the argument has evolved over time. In various exemplary embodiments, a similar feature can be used to trace the path of a piece of fact and/or evidence.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments according to this invention, as set forth above, are intended to be illustrative, not limiting. Various changes may be made without departing from the spirit and scope of the invention. Therefore, the invention is intended to embrace all known or later-developed alternatives, modifications variations, improvements, and/or substantial equivalents of these exemplary embodiments.

What is claimed is:

1. An argument visualization graphical user interface, comprising:
a hypothesis overview portion;
an evidence marshalling portion; and
an argument construction portion.

2. The argument visualization graphical user interface of claim 1, wherein the hypothesis overview portion; the evidence marshalling portion and the argument construction portion are combined into a hypothesis visualization tab.

3. The argument visualization graphical user interface of claim 2, further comprising at least one of an argument visualization tab, a hypotheses analyzer tab, a time analysis tab, and a hypotheses relationship tab.

4. The argument visualization graphical user interface of claim 1, wherein the hypothesis overview portion includes:
a hypothesis region usable to display at least one main hypothesis; and
a sub-hypothesis region usable to display at least one sub-hypothesis linkable to at least one of a main hypothesis displayed in the hypothesis portion and another sub-hypothesis displayed in the sub-hypothesis region.

5. The argument visualization graphical user interface of claim 4, wherein the hypothesis overview portion further includes at least one inference link that links one sub-hypothesis to one of a main hypothesis displayed in the hypothesis portion and another sub-hypothesis displayed in the sub-hypothesis region.

6. The argument visualization graphical user interface of claim 4, wherein the hypothesis overview portion further includes a conjecture region usable to display at least one conjecture.

7. The argument visualization graphical user interface of claim 1, wherein the evidence marshalling portion is usable to view facts and evidence and relationships between facts.

8. The argument visualization graphical user interface of claim 1, wherein the evidence marshalling portion includes:
at least two selection widgets, wherein each selection widget applies a different visualization to at least one of facts and evidence;
a visualization area usable to display the selected visualization selected using one of the at least two selection widgets; and
a description portion that is usable to display a description associated with a selected fact or evidence element.

9. The argument visualization graphical user interface of claim 8, wherein the evidence marshalling portion further includes at least two action widgets, wherein, when one of the at least two action widgets is selected, an action associated with the selected action widget is performed relative to the visualization displayed in the visualization area.

10. The argument visualization graphical user interface of claim 8, wherein the at least two selection widgets include at least two of:
a list visualization selection widget usable to select a list visualization;
a search visualization selection widget usable to select a search visualization;
a link analysis visualization selection widget usable to select a link analysis visualization; and
a timeline visualization selection widget usable to select a timeline visualization.

11. The argument visualization graphical user interface of claim 1, wherein the argument construction portion is usable to associate evidence and inferential links with various hypotheses and sub-hypotheses to create an argument.

12. The argument visualization graphical user interface of claim 1, wherein the argument construction portion includes:
an argument editing portion usable to display and construct an argument an argument; and
at least two action widgets, wherein, when one of the at least two action widgets is selected, an action associated with the selected action widget is performed relative to the argument displayed in the argument editing portion.

13. The argument visualization graphical user interface of claim 12, wherein the argument displayed in the argument editing portion includes:
a hypothesis;
zero, one or more sub-hypotheses;
at least one evidentiary fact; and
at least one inferential link, each inferential link extending between one of:
the hypothesis and a sub-hypothesis,
the hypothesis and an evidentiary fact that directly supports the hypothesis,
a first sub-hypotheses and a second sub-hypothesis,
a sub-hypothesis and an evidentiary fact that supports that sub-hypothesis, and
another inferential link and an evidentiary fact that supports that inferential link.

14. The argument visualization graphical user interface of claim 13, wherein an appearance of an inferential link indicates whether the inference supports or contradicts the hypothesis.

15. The argument visualization graphical user interface of claim 13, wherein the at least two action widgets include at least two of:
an add evidence action widget that allows evidentiary facts to be added to a Wigmore argument form and inferential links from the added evidentiary facts to be created;
an add sub-hypothesis action widget that allows sub-hypotheses to be added to a Wigmore argument form and inferential links from the added sub-hypotheses to be created;
an add data action widget that allows data elements to be added to a Toulmin argument form;
an add rebuttal action widget that allows rebuttal elements to be added to a Toulmin argument form;
a select Toulmin form action widget that causes the argument to be visualized using a Toulmin argument form; and
a select Wigmore form action widget that causes the argument to be visualized using a Wigmore argument form.

16. The argument visualization graphical user interface of claim 1, wherein the hypotheses analyzer tab comprises:
a selected hypothesis region usable to display at least one selected hypothesis of an argument being visualized using the argument visualization graphical user interface;
a fact element region usable to display at least one fact item of the an argument being visualized using the argument visualization graphical user interface; and
a control region usable to, wherein:
the fact element region includes a grid visualization, where each of the at least one fact item is associated with a row of the grid visualization and each of the at least one selected hypothesis is associated with a column of the grid visualization.

17. The argument visualization graphical user interface of claim 16, wherein the grid visualization includes a plurality of cells, each cell associated with a corresponding fact item and a corresponding selected hypothesis and displaying information relevant the corresponding fact and the corresponding hypothesis.

18. The argument visualization graphical user interface of claim 17, wherein the control region comprises at least some of:
a hypothesis selection widget usable to controllably select and deselect various ones of the hypotheses of the argument being visualized using the argument visualization graphical user interface;
a score function selection widget usable to select between a plurality of different scoring functions used to generate a score for each selected hypothesis;
a cell visualization widget usable to select a type of information to be displayed in the cells of the grid visualization;
a residual value selection widget usable to select a residual hypothesis, where each fact item not associated with any selected hypothesis is associated with the residual hypothesis;
a relevance-strength selection widget usable to select a basis for displaying in the cells of the grid visualization the information relevant to the corresponding facts and the corresponding hypotheses; and
a depth display widget usable to display a depth at which the corresponding fact is linked to the corresponding hypothesis.

19. The argument visualization graphical user interface of claim 16, wherein the selected hypothesis region comprises at least one sub-region, each sub-region associated with one selected hypothesis and displaying:
a name of that selected hypothesis;
a score for that selected hypothesis; and
a scoring graph element for that hypothesis.

20. The argument visualization graphical user interface of claim 19, wherein the score for each selected hypothesis is determined using Bayesian belief networks.

21. A method for visualizing an argument, comprising:
defining at least one hypothesis;
determining, for each of at least some of the at least one defined hypothesis, if that hypothesis supports at least one other defined hypothesis;
creating a link for each hypothesis determined to support at least one other defined hypothesis, between that hypothesis and each of at least one other defined hypothesis that hypothesis was determined to support;
defining at least one fact;
determining, for each of at least some of the defined facts, if that fact is relevant to at least one of the at least one defined hypothesis;
assigning a credibility value to at least some of the defined facts;
creating a link for each fact determined to be relevant to at least one hypothesis, between that fact and each of at least one hypothesis that fact was determined to be relevant to;
defining a relevance value to each created link;
displaying, for each of at least one defined hypothesis, an acyclic directed graph of that hypothesis, created links that connect other defined hypotheses or defined fact to that defined hypothesis, and the linked other defined hypotheses and the linked defined facts; and
determining a score value for each at least one defined hypothesis based on the displayed acyclic directed graph.
